(19) United States
(12) Patent Application Publication
(10) Pub. No.: US 2005/0037843 A1
(43) Pub. Date: Feb. 17, 2005

(54) Three-dimensional image display for a gaming apparatus

(76) Inventors: William Wells, Reno, NV (US); Craig Paulsen, Reno, NV (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/638,578

(22) Filed: Aug. 11, 2003

(51) Int. Cl. A63F 13/00

(52) U.S. Cl. 463/30

(57) ABSTRACT

A gaming apparatus may include a display unit capable of generating a non-planar, three-dimensional video image, a value input device, and a controller operatively coupled to the display unit and the value input device. The display unit may include a non-planar, three-dimensional display screen capable of displaying the non-planar, three-dimensional video images. The controller may comprise a processor and a memory, and may be programmed to allow a person to make a wager, to convert two-dimensional image data into three-dimensional image data, to cause a non-planar, three-dimensional video image to be generated on the display unit, and to determine a value payout associated with an outcome of a game.

### BACKGROUND

This patent is directed to a casino gaming apparatus, which could be either an individual gaming unit or a casino gaming system having a plurality of gaming units, each gaming unit including a display unit that displays three-dimensional images.

Conventional casino gaming units often included multiple display panels for displaying a variety of images. The gaming unit consisted of three separate displays: the top-box (or “top glass”), the belly (or “bottom”) glass, and the main player (or “primary”) display. The belly glass was typically a static, two-dimensional, planar image that provided game instructions, game information, casino information, images to attract players to the game, images to provide security, or images otherwise associated with the games that could be played on the gaming unit. The top-box has included a planar, two-dimensional monitor to display active, two-dimensional, planar images or a mechanical device having mechanical moving parts, either of which provided bonus game play or were used to attract players. The main player display has included active, planar images that may vary as part of a player-attract sequence or as part of the game play. Mechanical moving parts were often used to display a variety of images as part of the game play. For example, in a conventional slot machine, the main player display was a “reel glass” having multiple spinning reels with various images on each reel. Some of the active images provided by the top-box or main player display were three-dimensional objects shown as planar, two-dimensional images provided on a two-dimensional, planar display such as a CRT or flat-screen monitor. Conventional gaming units have also used optical beam-splitters or parabolic mirrors to generate virtual three-dimensional images from a composite of layered images from multiple sources.

### SUMMARY OF THE INVENTION

In one aspect, the invention is directed to a gaming apparatus that may include a display unit capable of generating non-planar, three-dimensional video images, a value input device, and a controller operatively coupled to the display unit and the value input device. The display unit may include first and second non-planar, three-dimensional screens each capable of displaying the non-planar, three-dimensional video images. The controller may comprise a processor and a memory, and may be programmed to allow a person to make a wager, to read a predetermined correction code, to convert two-dimensional image data into three-dimensional image data, and cause a first and second non-planar, three-dimensional video image to be generated on the display unit from said three-dimensional image data. The predetermined correction code may include an offset value, a correction value, a color value and a brightness value and may be associated with correcting one or more pixels of the two-dimensional image. The controller may convert the two-dimensional image data into three-dimensional image data by correcting for at least one of the following using said correction code: image distortion, brightness distortion and color aberrations. The first non-planar, three-dimensional video image may represent a game and the second non-planar, three-dimensional video image may represent a bonus game. The controller may determine an outcome of the game and the bonus game, and determine a value payout associated with the outcome of the game and the bonus game.

In another aspect, the invention is directed to a gaming apparatus that may include a display unit capable of generating non-planar, three-dimensional video images, a value input device, and a controller operatively coupled to the display unit and the value input device. The display unit may include a non-planar, three-dimensional screen in the shape of a dome capable of displaying the non-planar, three-dimensional video images. The controller may be programmed to convert two-dimensional image data into three-dimensional image data by correcting for at least one of the following distortions: image distortion, brightness distortion and color aberrations. The controller may be programmed to translate one or more pixels of the two-dimensional image data if the distortion comprises image distortion, vary the size of one or more pixels of the two-dimensional image data if the distortion comprises image distortion, adjust the brightness of one or more pixels of the two-dimensional image data if the distortion comprises brightness distortion, adjust the color of one or more pixels of the two-dimensional image data if the distortion comprises color aberrations. The controller may further be programmed to cause a non-planar, three-dimensional video image representing a game to be generated on the display unit from the three-dimensional image data, and determine a value payout associated with an outcome of the game.

In yet another aspect, the invention is directed to a gaming apparatus that may include a display unit capable of generating non-planar, three-dimensional video images, a value input device, and a controller operatively coupled to the display unit and the value input device. The display unit may include a non-planar, three-dimensional screen capable of displaying the non-planar, three-dimensional video images. The controller may comprise a processor and a memory, and may be programmed to allow a person to make a wager, to convert two-dimensional image data into three-dimensional image data, cause a non-planar, three-dimensional video image to be generated on the display unit from said three-dimensional image data, and to determine an outcome of a game and a value payout associated with the outcome of the game.

The non-planar, three-dimensional video image may represent one of the following games: video poker, video blackjack, video slots, video keno and video bingo, in which case the non-planar, three-dimensional video image may comprise an image of at least five playing cards if the game comprises video poker; the non-planar, three-dimensional video image may comprise an image of a plurality of simulated slot machine reels if the game comprises video slots; the non-planar, three-dimensional video image may comprise an image of a plurality of playing cards if the game comprises video blackjack; the non-planar, three-dimensional video image may comprise an image of a plurality of keno numbers if the game comprises video keno, and the non-planar, three-dimensional video image may comprise an image of a bingo grid if the game comprises video bingo.

The display unit may further include a light engine and a projection lens assembly. The display unit may also further include a second display screen. The second display screen may be a planar, two-dimensional screen or a non-planar, three-dimensional display screen. The non-planar, three-dimensional display screen may be in the shape of a dome, a human face and a half-cylinder. The controller may further be programmed to cause a non-planar, three-dimensional video image of one of the following to generated on the non-planar, three-dimensional screen: a face, a bonus game, a payout table, casino information, game information, game instructions, an advertisement, a movie, an animation and an attraction sequence. The non-planar, three-dimensional display screen may include an inner surface and an outer surface. The three-dimensional video image may be projected on the inner surface and viewed by a person on the inner surface or the outer surface. The gaming apparatus may further include one or more controls to allow a person to manipulate the three-dimensional video image. The controls may include motion-sensitive controls, touch-sensitive controls and controls responsive to the person's eye movements.

The controller may further include a three-dimensional image controller programmed to receive two-dimensional image data, correct the two-dimensional image data for at least one of the following: image distortion, brightness distortion and color aberrations, and display the corrected two-dimensional image data as a non-planar, three-dimensional video image on the non-planar, three-dimensional display screen. The three-dimensional image controller may include an image processor and a correction memory operatively coupled to the image processor, and be programmed to translate one or more pixels of the two-dimensional image data to correct for image distortions, vary the size of one or more pixels of the two-dimensional image data to correct for image distortion, adjust the color of one or more pixels of the two-dimensional image data to correct for color aberration and adjust the brightness of one or more pixels of the two-dimensional image data to correct for brightness distortion.

The controller may be programmed to receive three-dimensional image data, to correct for at least one of the following: image distortion, brightness distortion and color aberrations when the three-dimensional image data is displayed on the non-planar, three-dimensional display screen as a video image, and to cause a non-planar, three-dimensional video image representing a game to be generated on the display unit from the corrected three-dimensional image data. The three-dimensional image data may be planar or non-planar three-dimensional image data.

The invention is also directed to a gaming method that may comprise receiving two-dimensional image data, converting said two-dimensional image data into three-dimensional image data, causing a non-planar, three-dimensional video image representing a game to be generated on a non-planar, three-dimensional display screen from said three-dimensional image data, and determining a value payout associated with an outcome of the game.

Additional aspects of the invention are defined by the claims of this patent.

### BRIEF DESCRIPTION OF THE DRAWINGS

FIG. 1 is a block diagram of an embodiment of a gaming system in accordance with the invention;

FIG. 2 is a perspective view of an embodiment of one of the gaming units shown schematically in FIG. 1;

FIG. 2A illustrates an embodiment of a control panel for a gaming unit;

FIG. 3 is a block diagram of the electronic components of the gaming unit of FIG. 2;

FIG. 4 is a flowchart of an embodiment of a main routine that may be performed during operation of one or more of the gaming units;

FIG. 5 is a flowchart of an alternative embodiment of a main routine that may be performed during operation of one or more of the gaming units;

FIG. 6 is an illustration of an embodiment of a visual display that may be displayed during performance of the video poker routine of FIG. 8;

FIG. 7 is an illustration of an embodiment of a visual display that may be displayed during performance of the video blackjack routine of FIG. 9;

FIG. 8 is a flowchart of an embodiment of a video poker routine that may be performed by one or more of the gaming units;

FIG. 9 is a flowchart of an embodiment of a video blackjack routine that may be performed by one or more of the gaming units;

FIG. 10 is an illustration of an embodiment of a visual display that may be displayed during performance of the slots routine of FIG. 12;

FIG. 11 is an illustration of an embodiment of a visual display that may be displayed during performance of the video keno routine of FIG. 13;

FIG. 12 is a flowchart of an embodiment of a slots routine that may be performed by one or more of the gaming units;

FIG. 13 is a flowchart of an embodiment of a video keno routine that may be performed by one or more of the gaming units;

FIG. 14 is an illustration of an embodiment of a visual display that may be displayed during performance of the video bingo routine of FIG. 15;

FIG. 15 is a flowchart of an embodiment of a video bingo routine that may be performed by one or more of the gaming units;

FIG. 16 is a block diagram of an embodiment of a three-dimensional projection system;

FIG. 17 is a block diagram of an embodiment of a light engine for a three-dimensional projection system;

FIG. 18 is a block diagram of an embodiment of a micro-display engine for a three-dimensional projection system;

FIG. 19 is a block diagram of another embodiment of a micro-engine display for a three-dimensional projection system;

FIG. 20 is a cross-sectional side view of an embodiment of a three-dimensional display screen;

FIG. 21 is a block diagram of an embodiment of a three-dimensional image controller;

FIG. 22 is a schematic representation of an embodiment of a correction technique; and

FIG. 23 is a flowchart of an embodiment of a correction routine that may be performed by a three-dimensional image controller.

### DETAILED DESCRIPTION OF VARIOUS EMBODIMENTS

Although the following text sets forth a detailed description of numerous different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

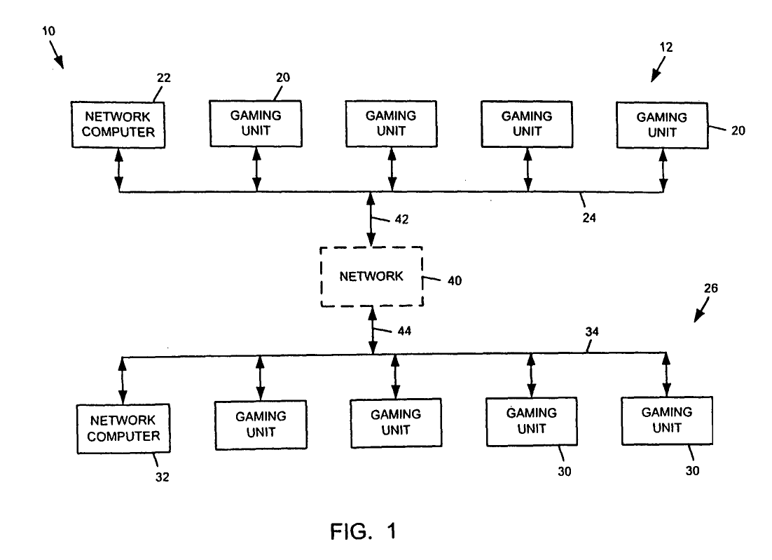

FIG. 1 illustrates one possible embodiment of a casino gaming system 10 in accordance with the invention. Referring to FIG. 1, the casino gaming system 10 may include a first group or network 12 of casino gaming units 20 operatively coupled to a network computer 22 via a network data link or bus 24. The casino gaming system 10 may include a second group or network 26 of casino gaming units 30 operatively coupled to a network computer 32 via a network data link or bus 34. The first and second gaming networks 12, 26 may be operatively coupled to each other via a network 40, which may comprise, for example, the Internet, a wide area network (WAN), or a local area network (LAN) via a first network link 42 and a second network link 44.

The first network 12 of gaming units 20 may be provided in a first casino, and the second network 26 of gaming units 30 may be provided in a second casino located in a separate geographic location than the first casino. For example, the two casinos may be located in different areas of the same city, or they may be located in different states. The network 40 may include a plurality of network computers or server computers (not shown), each of which may be operatively interconnected. Where the network 40 comprises the Internet, data communication may take place over the communication links 42, 44 via an Internet communication protocol.

The network computer 22 may be a server computer and may be used to accumulate and analyze data relating to the operation of the gaming units 20. For example, the network computer 22 may continuously receive data from each of the gaming units 20 indicative of the dollar amount and number of wagers being made on each of the gaming units 20, data indicative of how much each of the gaming units 20 is paying out in winnings, data regarding the identity and gaming habits of players playing each of the gaming units 20, etc. The network computer 32 may be a server computer and may be used to perform the same or different functions in relation to the gaming units 30 as the network computer 22 described above.

Although each network 12, 26 is shown to include one network computer 22, 32 and four gaming units 20, 30, it should be understood that different numbers of computers and gaming units may be utilized. For example, the network 12 may include a plurality of network computers 22 and tens or hundreds of gaming units 20, all of which may be interconnected via the data link 24. The data link 24 may be provided as a dedicated hardwired link or a wireless link. Although the data link 24 is shown as a single data link 24, the data link 24 may comprise multiple data links.

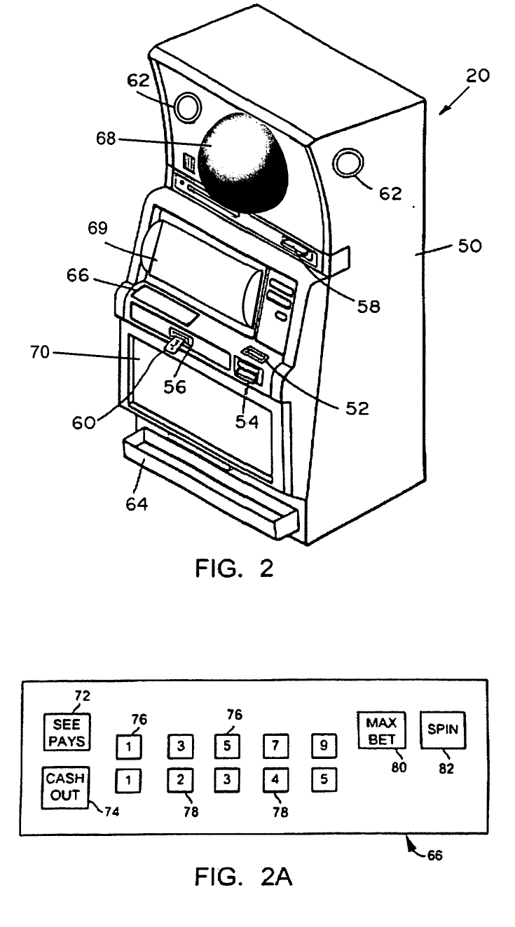

FIG. 2 is a perspective view of one possible embodiment of one or more of the gaming units 20. Although the following description addresses the design of the gaming units 20, it should be understood that the gaming units 30 may have the same design as the gaming units 20 described below. It should be understood that the design of one or more of the gaming units 20 may be different than the design of other gaming units 20, and that the design of one or more of the gaming units 30 may be different than the design of other gaming units 30. Each gaming unit 20 may be any type of casino gaming unit and may have various different structures and methods of operation. For exemplary purposes, various designs of the gaming units 20 are described below, but it should be understood that numerous other designs may be utilized.

Referring to FIG. 2, the casino gaming unit 20 may include a housing or cabinet 50 and one or more input devices, which may include a coin slot or acceptor 52, a paper currency acceptor 54, a ticket reader/printer 56 and a card reader 58, which may be used to input value to the gaming unit 20. A value input device may include any device that can accept value from a customer. As used herein, the term “value” may encompass gaming tokens, coins, paper currency, ticket vouchers, credit or debit cards, smart cards, and any other object representative of value.

If provided on the gaming unit 20, the ticket reader/printer 56 may be used to read and/or print or otherwise encode ticket vouchers 60. The ticket vouchers 60 may be composed of paper or another printable or encodable material and may have one or more of the following informational items printed or encoded thereon: the casino name, the type of ticket voucher, a validation number, a bar code with control and/or security data, the date and time of issuance of the ticket voucher, redemption instructions and restrictions, a description of an award, and any other information that may be necessary or desirable. Different types of ticket vouchers 60 could be used, such as bonus ticket vouchers, cash-redemption ticket vouchers, casino chip ticket vouchers, extra game play ticket vouchers, merchandise ticket vouchers, restaurant ticket vouchers, show ticket vouchers, etc. The ticket vouchers 60 could be printed with an optically readable material such as ink, or data on the ticket vouchers 60 could be magnetically encoded. The ticket reader/printer 56 may be provided with the ability to both read and print ticket vouchers 60, or it may be provided with the ability to only read or only print or encode ticket vouchers 60. In the latter case, for example, some of the gaming units 20 may have ticket printers 56 that may be used to print ticket vouchers 60, which could then be used by a player in other gaming units 20 that have ticket readers 56.

If provided, the card reader 58 may include any type of card reading device, such as a magnetic card reader or an optical card reader, and may be used to read data from a card offered by a player, such as a credit card or a player tracking card. If provided for player tracking purposes, the card reader 58 may be used to read data from, and/or write data to, player tracking cards that are capable of storing data representing the identity of a player, the identity of a casino, the player's gaming habits, etc.

The gaming unit 20 may include one or more audio speakers 62, a coin payout tray 64, an input control panel 66, and one or more color video display units 68, 69, 70 for displaying images relating to the game or games provided by the gaming unit 20. The display units 68, 69, 70 may be a top-box display 68, a main player display 69, and a belly glass display 70. The size, shape and number of display units 68, 69, 70 may vary. Some display units may be three-dimensional display units 68, 69, as explained further below, whereas others may be two-dimensional display units 70. In one example, the gaming machine 20 may only have one three-dimensional display unit for the entire gaming machine. Though FIG. 2 is shown to include a three-dimensional display unit for the top-box display 68 and the main player display 69, and a two-dimensional display for the belly glass display 70, those of ordinary skill in the art will recognize that each display unit 68, 69, 70 may each be a three-dimensional display or a two-dimensional display. Each display unit 68, 69, 70 may display animated or static video images. The audio speakers 62 may generate audio representing sounds such as the noise of spinning slot machine reels, a dealer's voice, music, announcements or any other audio related to a casino game. The input control panel 66 may be provided with a plurality of pushbuttons, touch-sensitive areas or motion-sensitive areas that may be pressed or motioned to by a player to select games, make wagers, make gaming decisions, etc.

FIG. 2A illustrates one possible embodiment of the control panel 66, which may be used where the gaming unit 20 is a slot machine having a plurality of mechanical or “virtual” reels. Referring to FIG. 2A, the control panel 66 may include a “See Pays” button 72 that, when activated, causes one or more of the display units 68, 69, 70 to generate one or more display screens showing the odds or payout information for the game or games provided by the gaming unit 20. As used herein, the term “button” is intended to encompass any device that allows a player to make an input, such as an input device that must be depressed to make an input selection or a display area that a player may simply touch. The control panel 66 may include a “Cash Out” button 74 that may be activated when a player decides to terminate play on the gaming unit 20, in which case the gaming unit 20 may return value to the player, such as by returning a number of coins to the player via the payout tray 64.

If the gaming unit 20 provides a slots game having a plurality of reels and a plurality of paylines which define winning combinations of reel symbols, the control panel 66 may be provided with a plurality of selection buttons 76, each of which allows the player to select a different number of paylines prior to spinning the reels. For example, five buttons 76 may be provided, each of which may allow a player to select one, three, five, seven or nine paylines.

If the gaming unit 20 provides a slots game having a plurality of reels, the control panel 66 may be provided with a plurality of selection buttons 78 each of which allows a player to specify a wager amount for each payline selected. For example, if the smallest wager accepted by the gaming unit 20 is a quarter ($0.25), the gaming unit 20 may be provided with five selection buttons 78, each of which may allow a player to select one, two, three, four or five quarters to wager for each payline selected. In that case, if a player were to activate the “5” button 76 (meaning that five paylines were to be played on the next spin of the reels) and then activate the “3” button 78 (meaning that three coins per payline were to be wagered), the total wager would be $3.75 (assuming the minimum bet was $0.25).

The control panel 66 may include a “Max Bet” button 80 to allow a player to make the maximum wager allowable for a game. In the above example, where up to nine paylines were provided and up to five quarters could be wagered for each payline selected, the maximum wager would be 45 quarters, or $11.25. The control panel 66 may include a spin button 82 to allow the player to initiate spinning of the reels of a slots game after a wager has been made.

In FIG. 2A, a rectangle is shown around the buttons 72, 74, 76, 78, 80, 82. It should be understood that that rectangle simply designates, for ease of reference, an area in which the buttons 72, 74, 76, 78, 80, 82 may be located. Consequently, the term “control panel” should not be construed to imply that a panel or plate separate from the housing 50 of the gaming unit 20 is required, and the term “control panel” may encompass a plurality or grouping of player activatable buttons.

Although one possible control panel 66 is described above, it should be understood that different buttons could be utilized in the control panel 66, and that the particular buttons used may depend on the game or games that could be played on the gaming unit 20. Although the control panel 66 is shown to be separate from the display units 68, 69, 70, it should be understood that the control panel 66 could be generated by one or more of the display units 68, 69, 70. In that case, each of the buttons of the control panel 66 could be a colored area generated by one or more of the display units 68, 69, 70, and some type of mechanism may be associated with the display units 68, 69, 70 to detect when each of the buttons was touched, such as a touch-sensitive screen. Motion sensors may also be employed to cooperative with the display units 68, 69, 70 to provide a motion-sensitive screen to monitor a player's movements to detect when a button was touched. In such a case, the player may not need to physically touch the button, but rather a three-dimensional video image offers the perception that the player is touching the button. By reading the player's movements, the gaming unit 20 may determine which button the player selected.

### Gaming Unit Electronics

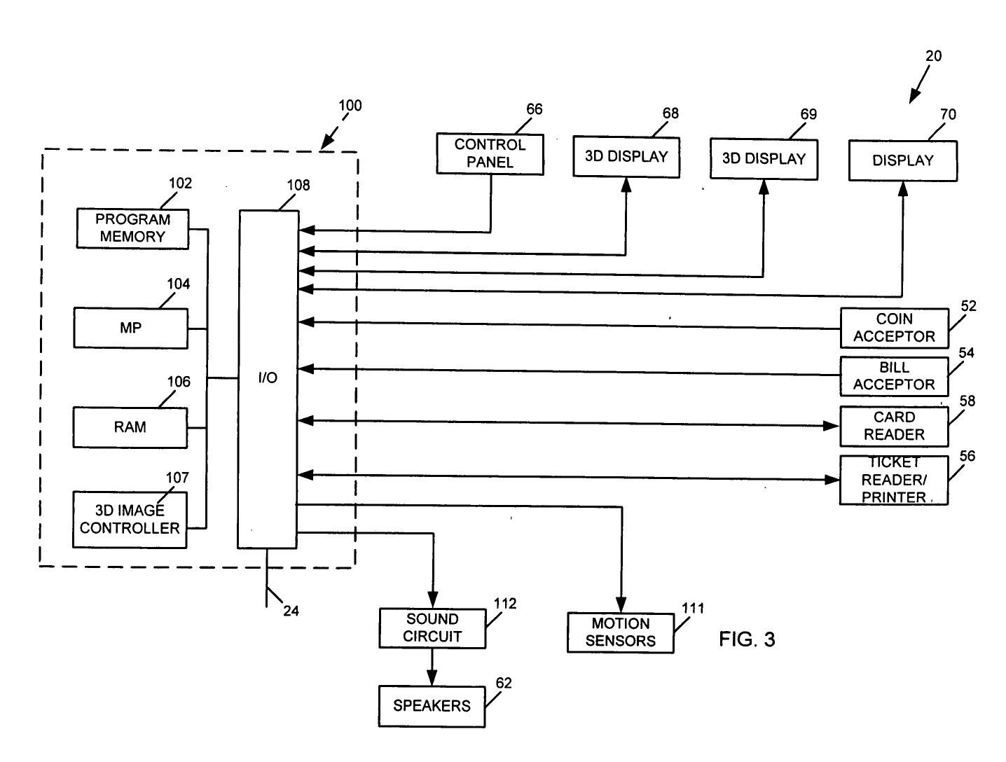

FIG. 3 is a block diagram of a number of components that may be incorporated in the gaming unit 20. Referring to FIG. 3, the gaming unit 20 may include a controller 100 that may comprise a program memory 102, a microcontroller or microprocessor (MP) 104, a random-access memory (RAM) 106, a three-dimensional image controller 107 and an input/output (I/O) circuit 108, all of which may be interconnected via an address/data bus 110. It should be appreciated that although only one microprocessor 104 is shown, the controller 100 may include multiple microprocessors 104. Similarly, the memory of the controller 100 may include multiple RAMs 106 and multiple program memories 102. Although the I/O circuit 108 is shown as a single block, it should be appreciated that the I/O circuit 108 may include a number of different types of I/O circuits. The RAM(s) 104 and program memories 102 may be implemented as semiconductor memories, magnetically readable memories, and/or optically readable memories, for example.

Although the program memory 102 is shown in FIG. 3 as a read-only memory (ROM) 102, the program memory of the controller 100 may be a read/write or alterable memory, such as a hard disk. In the event a hard disk is used as a program memory, the address/data bus 110 shown schematically in FIG. 3 may comprise multiple address/data buses, which may be of different types, and there may be an I/O circuit disposed between the address/data buses.

FIG. 3 illustrates that the control panel 66, the coin acceptor 52, the bill acceptor 54, the card reader 58 and the ticket reader/printer 56 may be operatively coupled to the I/O circuit 108, each of those components being so coupled by either a unidirectional or bidirectional, single-line or multiple-line data link, which may depend on the design of the component that is used. The speaker(s) 62 may be operatively coupled to a sound circuit 112, that may comprise a voice- and sound-synthesis circuit or that may comprise a driver circuit. The sound-generating circuit 112 may be coupled to the I/O circuit 108. The three-dimensional display units 68, 69 and the two-dimensional display unit 70 may be operatively coupled to the I/O circuit 108 via unidirectional or bidirectional, single-line or multiple-line data link, to send and receive signals for video images to be displayed. One or more motions sensors 111 may be operatively coupled to the I/O circuit 108 which may be used to facilitate the control over the gaming unit 20.

As shown in FIG. 3, the components 52, 54, 56, 58, 66, 112 may be connected to the I/O circuit 108 via a respective direct line or conductor. Different connection schemes could be used. For example, one or more of the components shown in FIG. 3 may be connected to the I/O circuit 108 via a common bus or other data link that is shared by a number of components. Furthermore, some of the components may be directly connected to the microprocessor 104 without passing through the I/O circuit 108.

### Overall Operation of Gaming Unit

One manner in which one or more of the gaming units 20 (and one or more of the gaming units 30) may operate is described below in connection with a number of flowcharts which represent a number of portions or routines of one or more computer programs, which may be stored in one or more of the memories of the controller 100. The computer program(s) or portions thereof may be stored remotely, outside of the gaming unit 20, and may control the operation of the gaming unit 20 from a remote location. Such remote control may be facilitated with the use of a wireless connection, or by an Internet interface that connects the gaming unit 20 with a remote computer (such as one of the network computers 22, 32) having a memory in which the computer program portions are stored. The computer program portions may be written in any high level language such as C, C++, C#, Java or the like or any low-level assembly or machine language. By storing the computer program portions therein, various portions of the memories 102, 106 are physically and/or structurally configured in accordance with computer program instructions.

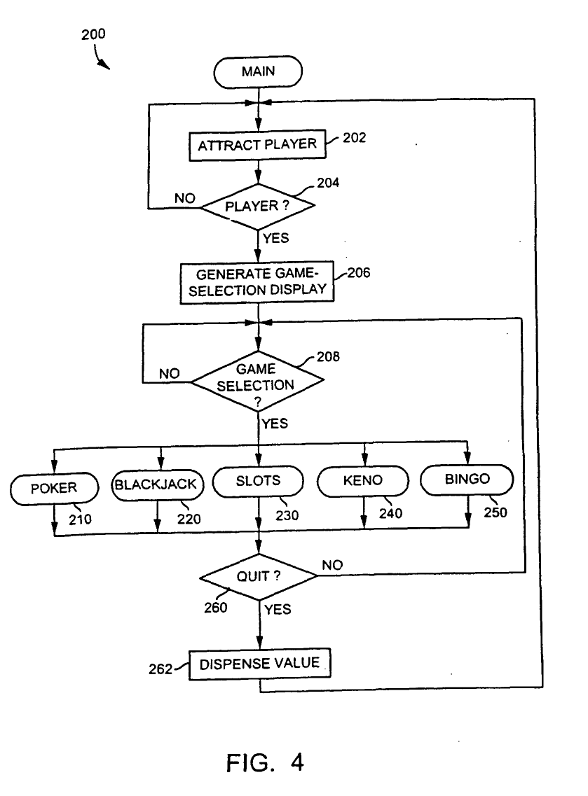

FIG. 4 is a flowchart of a main operating routine 200 that may be stored in the memory of the controller 100. Referring to FIG. 4, the main routine 200 may begin operation at block 202 during which an attraction sequence may be performed in an attempt to induce a potential player in a casino to play the gaming unit 20. The attraction sequence may be performed by displaying one or more video images on the display units 68, 69, 70 and/or causing one or more sound segments, such as voice or music, to be generated via the speakers 62. The attraction sequence may include a scrolling list of games that may be played on the gaming unit 20 and/or video images of various games being played, such as video poker, video blackjack, video slots, video keno, video bingo, etc.

During performance of the attraction sequence, if a potential player makes any input to the gaming unit 20 as determined at block 204, the attraction sequence may be terminated and a game-selection display may be generated on the display unit 69 at block 206 to allow the player to select a game available on the gaming unit 20. The gaming unit 20 may detect an input at block 204 in various ways. For example, the gaming unit 20 could detect if the player presses any button on the gaming unit 20; the gaming unit 20 could determine if the player deposited one or more coins into the gaming unit 20; the gaming unit 20 could determine if player deposited paper currency into the gaming unit; etc. While the following description may describe various displays that may be generated on the display unit 69, the same or similar displays may be generated on the display units 68, 70.

The game-selection display generated at block 206 may include, for example, a list of video games that may be played on the gaming unit 20 and/or a visual message to prompt the player to deposit value into the gaming unit 20. While the game-selection display is generated, the gaming unit 20 may wait for the player to make a game selection. Upon selection of one of the games by the player as determined at block 208, the controller 100 may cause one of a number of game routines to be performed to allow the selected game to be played. For example, the game routines could include a video poker routine 210, a video blackjack routine 220, a slots routine 230, a video keno routine 240, and a video bingo routine 250. At block 208, if no game selection is made within a given period of time, the operation may branch back to block 202.

After one of the routines 210, 220, 230, 240, 250 has been performed to allow the player to play one of the games, block 260 may be utilized to determine whether the player wishes to terminate play on the gaming unit 20 or to select another game. If the player wishes to stop playing the gaming unit 20, which wish may be expressed, for example, by selecting a “Cash Out” button, the controller 100 may dispense value to the player at block 262 based on the outcome of the game(s) played by the player. The operation may then return to block 202. If the player did not wish to quit as determined at block 260, the routine may return to block 208 where the game-selection display may again be generated to allow the player to select another game.

It should be noted that although five gaming routines are shown in FIG. 4, a different number of routines could be included to allow play of a different number of games. The gaming unit 20 may also be programmed to allow play of different games.

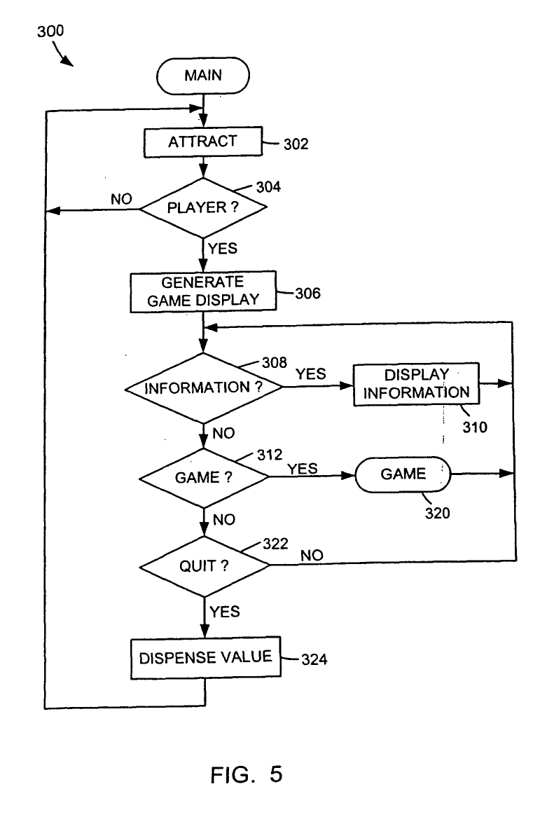

FIG. 5 is a flowchart of an alternative main operating routine 300 that may be stored in the memory of the controller 100. The main routine 300 may be utilized for gaming units 20 that are designed to allow play of only a single game or single type of game. Referring to FIG. 5, the main routine 300 may begin operation at block 302 during which an attraction sequence may be performed in an attempt to induce a potential player in a casino to play the gaming unit 20. The attraction sequence may be performed by displaying one or more video images on the display units 68, 69, 70 and/or causing one or more sound segments, such as voice or music, to be generated via the speakers 62.

During performance of the attraction sequence, if a potential player makes any input to the gaming unit 20 as determined at block 304, the attraction sequence may be terminated and a game display may be generated on the display unit 69 at block 306. The game display generated at block 306 may include, for example, an image of the casino game that may be played on the gaming unit 20 and/or a visual message to prompt the player to deposit value into the gaming unit 20. At block 308, the gaming unit 20 may determine if the player requested information concerning the game, in which case the requested information may be displayed at block 310. Block 312 may be used to determine if the player requested initiation of a game, in which case a game routine 320 may be performed. The game routine 320 could be any one of the game routines disclosed herein, such as one of the five game routines 210, 220, 230, 240, 250, or another game routine.

After the routine 320 has been performed to allow the player to play the game, block 322 may be utilized to determine whether the player wishes to terminate play on the gaming unit 20. If the player wishes to stop playing the gaming unit 20, which wish may be expressed, for example, by selecting a “Cash Out” button, the controller 100 may dispense value to the player at block 324 based on the outcome of the game(s) played by the player. The operation may then return to block 302. If the player did not wish to quit as determined at block 322, the operation may return to block 308.

### Video Poker

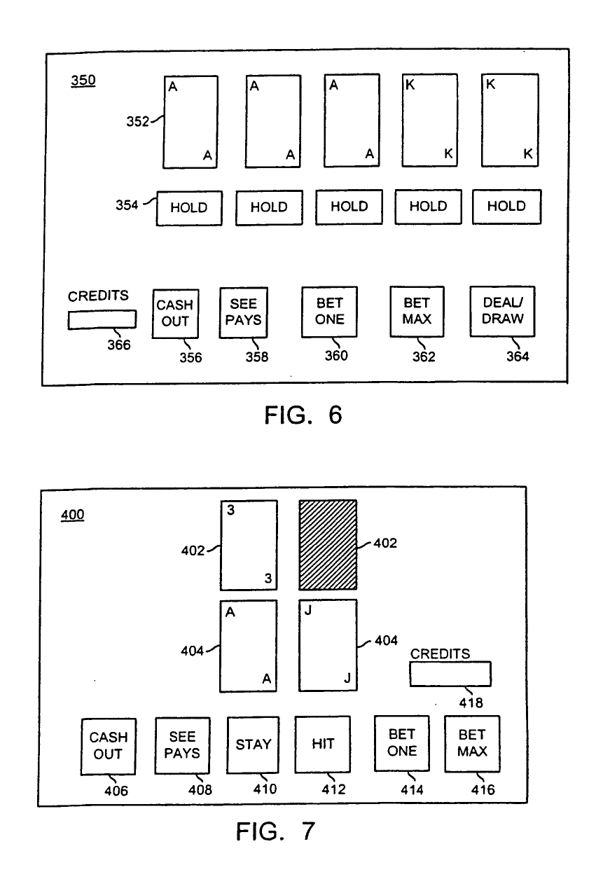

FIG. 6 is an exemplary display 350 that may be shown on the display unit 69 during performance of the video poker routine 210 shown schematically in FIG. 4. Referring to FIG. 6, the display 350 may include video images 352 of a plurality of playing cards representing the player's hand, such as five cards. To allow the player to control the play of the video poker game, a plurality of player-selectable buttons may be displayed. The buttons may include a “Hold” button 354 disposed directly below each of the playing card images 352, a “Cash Out” button 356, a “See Pays” button 358, a “Bet One Credit” button 360, a “Bet Max Credits” button 362, and a “Deal/Draw” button 364. The display 350 may also include an area 366 in which the number of remaining credits or value is displayed. If the display unit 69 is provided with a touch-sensitive or motion-sensitive screen, the buttons 354, 356, 358, 360, 362, 364 may form part of the video display 350. Alternatively, one or more of those buttons may be provided as part of a control panel that is provided separately from the display units 68, 69, 70.

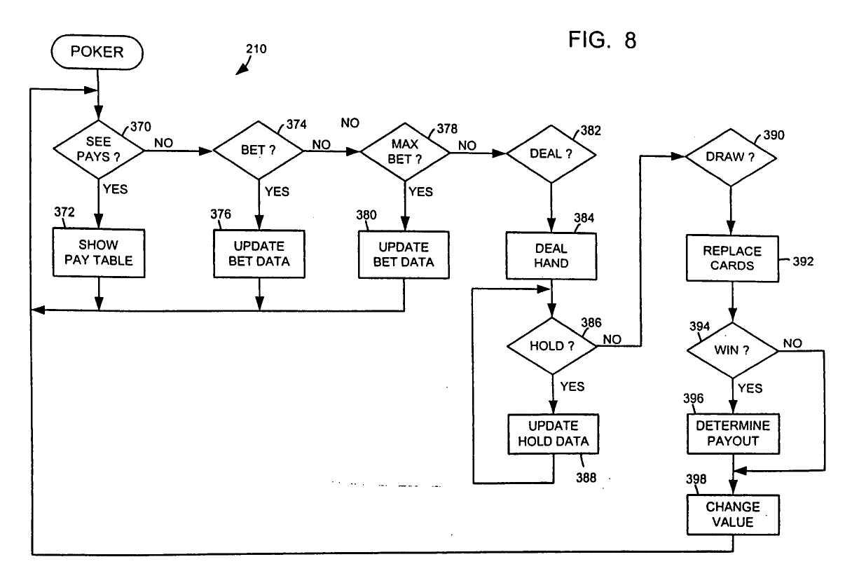

FIG. 8 is a flowchart of the video poker routine 210 shown schematically in FIG. 4. Referring to FIG. 8, at block 370, the routine may determine whether the player has requested payout information, such as by activating the “See Pays” button 358, in which case at block 372 the routine may cause one or more pay tables to be displayed on the display unit 69. At block 374, the routine may determine whether the player has made a bet, such as by pressing the “Bet One Credit” button 360, in which case at block 376 bet data corresponding to the bet made by the player may be stored in the memory of the controller 100. At block 378, the routine may determine whether the player has pressed the “Bet Max Credits” button 362, in which case at block 380 bet data corresponding to the maximum allowable bet may be stored in the memory of the controller 100.

At block 382, the routine may determine if the player desires a new hand to be dealt, which may be determined by detecting if the “Deal/Draw” button 364 was activated after a wager was made. In that case, at block 384 a video poker hand may be “dealt” by causing the display unit 69 to generate the playing card images 352. After the hand is dealt, at block 386 the routine may determine if any of the “Hold” buttons 354 have been activated by the player, in which case data regarding which of the playing card images 352 are to be “held” may be stored in the controller 100 at block 388. If the “Deal/Draw” button 364 is activated again as determined at block 390, each of the playing card images 352 that was not “held” may be caused to disappear from the video display 350 and to be replaced by a new, randomly selected, playing card image 352 at block 392.

At block 394, the routine may determine whether the poker hand represented by the playing card images 352 currently displayed is a winner. That determination may be made by comparing data representing the currently displayed poker hand with data representing all possible winning hands, which may be stored in the memory of the controller 100. If there is a winning hand, a payout value corresponding to the winning hand may be determined at block 396. At block 398, the player's cumulative value or number of credits may be updated by subtracting the bet made by the player and adding, if the hand was a winner, the payout value determined at block 396. The cumulative value or number of credits may also be displayed in the display area 366 (FIG. 6).

Although the video poker routine 210 is described above in connection with a single poker hand of five cards, the routine 210 may be modified to allow other versions of poker to be played. For example, seven card poker may be played, or stud poker may be played. Alternatively, multiple poker hands may be simultaneously played. In that case, the game may begin by dealing a single poker hand, and the player may be allowed to hold certain cards. After deciding which cards to hold, the held cards may be duplicated in a plurality of different poker hands, with the remaining cards for each of those poker hands being randomly determined.

### Video Blackjack

FIG. 7 is an exemplary display 400 that may be shown on the display unit 69 during performance of the video blackjack routine 220 shown schematically in FIG. 4. Referring to FIG. 7, the display 400 may include video images 402 of a pair of playing cards representing a dealer's hand, with one of the cards shown face up and the other card being shown face down, and video images 404 of a pair of playing cards representing a player's hand, with both the cards shown face up. The “dealer” may be the gaming unit 20.

To allow the player to control the play of the video blackjack game, a plurality of player-selectable buttons may be displayed. The buttons may include a “Cash Out” button 406, a “See Pays” button 408, a “Stay” button 410, a “Hit” button 412, a “Bet One Credit” button 414, and a “Bet Max Credits” button 416. The display 400 may also include an area 418 in which the number of remaining credits or value is displayed. If the display unit 69 is provided with a touch-sensitive or motion-sensitive screen, the buttons 406, 408, 410, 412, 414, 416 may form part of the video display 400. Alternatively, one or more of those buttons may be provided as part of a control panel that is provided separately from the display units 68, 69, 70.

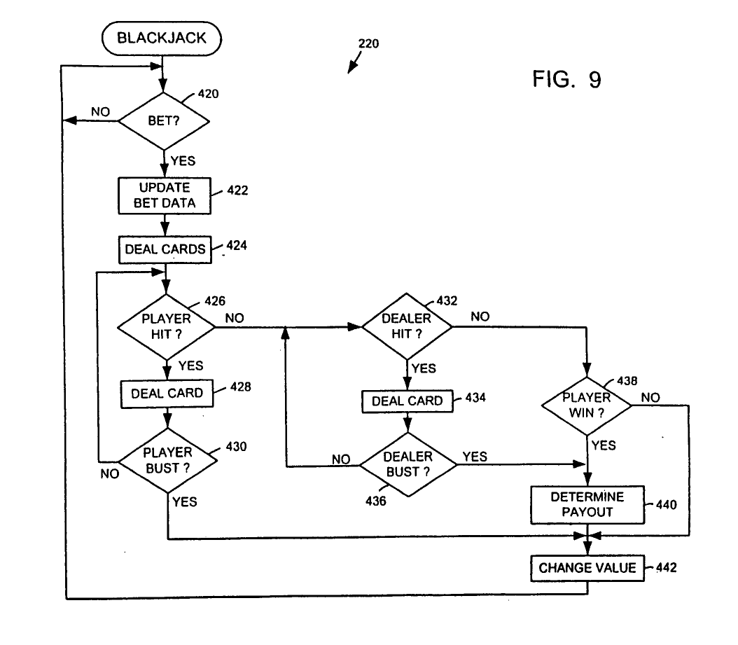

FIG. 9 is a flowchart of the video blackjack routine 220 shown schematically in FIG. 4. Referring to FIG. 9, the video blackjack routine 220 may begin at block 420 where it may determine whether a bet has been made by the player. That may be determined, for example, by detecting the activation of either the “Bet One Credit” button 414 or the “Bet Max Credits” button 416. At block 422, bet data corresponding to the bet made at block 420 may be stored in the memory of the controller 100. At block 424, a dealer's hand and a player's hand may be “dealt” by making the playing card images 402, 404 appear on the display unit 69.

At block 426, the player may be allowed to be “hit,” in which case at block 428 another card will be dealt to the player's hand by making another playing card image 404 appear in the display 400. If the player is hit, block 430 may determine if the player has “bust,” or exceeded 21. If the player has not bust, blocks 426 and 428 may be performed again to allow the player to be hit again.

If the player decides not to hit, at block 432 the routine may determine whether the dealer should be hit. Whether the dealer hits may be determined in accordance with predetermined rules, such as the dealer always hit if the dealer's hand totals 15 or less. If the dealer hits, at block 434 the dealer's hand may be dealt another card by making another playing card image 402 appear in the display 400. At block 436 the routine may determine whether the dealer has bust. If the dealer has not bust, blocks 432, 434 may be performed again to allow the dealer to be hit again.

If the dealer does not hit, at block 436 the outcome of the blackjack game and a corresponding payout may be determined based on, for example, whether the player or the dealer has the higher hand that does not exceed 21. If the player has a winning hand, a payout value corresponding to the winning hand may be determined at block 440. At block 442, the player's cumulative value or number of credits may be updated by subtracting the bet made by the player and adding, if the player won, the payout value determined at block 440. The cumulative value or number of credits may also be displayed in the display area 418 (FIG. 7).

### Slots

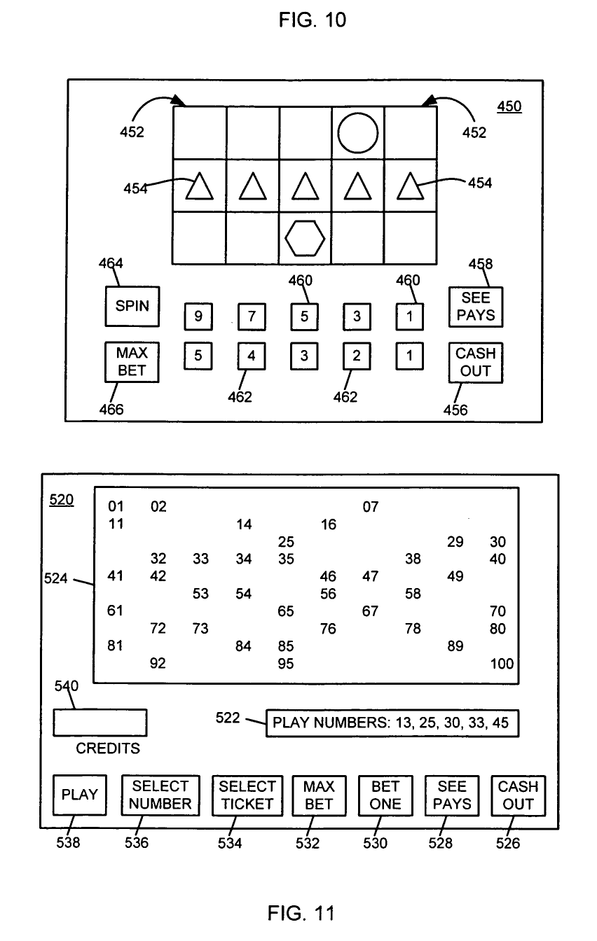

FIG. 10 is an exemplary display 450 that may be shown on the display unit 69 during performance of the slots routine 230 shown schematically in FIG. 4. Referring to FIG. 10, the display 450 may include video images 452 of a plurality of slot machine reels, each of the reels having a plurality of reel symbols 454 associated therewith. Although the display 450 shows five reel images 452, each of which may have three reel symbols 454 that are visible at a time, other reel configurations could be utilized.

To allow the player to control the play of the slots game, a plurality of player-selectable buttons may be displayed. The buttons may include a “Cash Out” button 456, a “See Pays” button 458, a plurality of payline-selection buttons 460 each of which allows the player to select a different number of paylines prior to “spinning” the reels, a plurality of bet-selection buttons 462 each of which allows a player to specify a wager amount for each payline selected, a “Spin” button 464, and a “Max Bet” button 466 to allow a player to make the maximum wager allowable.

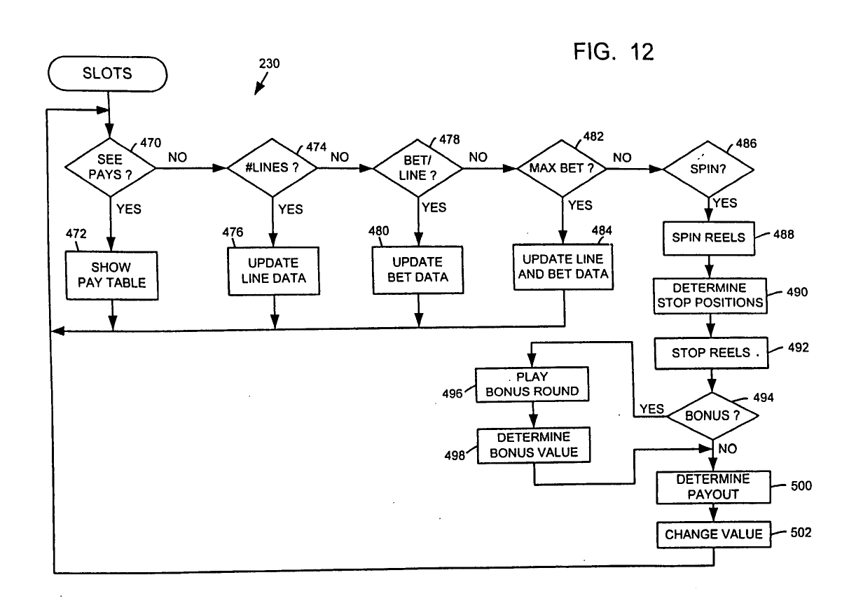

FIG. 12 is a flowchart of the slots routine 230 shown schematically in FIG. 10. Referring to FIG. 12, at block 470, the routine may determine whether the player has requested payout information, such as by activating the “See Pays” button 458, in which case at block 472 the routine may cause one or more pay tables to be displayed on the display unit 69. At block 474, the routine may determine whether the player has pressed one of the payline-selection buttons 460, in which case at block 476 data corresponding to the number of paylines selected by the player may be stored in the memory of the controller 100. At block 478, the routine may determine whether the player has pressed one of the bet-selection buttons 462, in which case at block 480 data corresponding to the amount bet per payline may be stored in the memory of the controller 100. At block 482, the routine may determine whether the player has pressed the “Max Bet” button 466, in which case at block 484 bet data (which may include both payline data and bet-per-payline data) corresponding to the maximum allowable bet may be stored in the memory of the controller 100.

If the “Spin” button 464 has been activated by the player as determined at block 486, at block 488 the routine may cause the slot machine reel images 452 to begin “spinning” so as to simulate the appearance of a plurality of spinning mechanical slot machine reels. At block 490, the routine may determine the positions at which the slot machine reel images will stop, or the particular symbol images 454 that will be displayed when the reel images 452 stop spinning. At block 492, the routine may stop the reel images 452 from spinning by displaying stationary reel images 452 and images of three symbols 454 for each stopped reel image 452. The virtual reels may be stopped from left to right, from the perspective of the player, or in any other manner or sequence.

The routine may provide for the possibility of a bonus game or round if certain conditions are met, such as the display in the stopped reel images 452 of a particular symbol 454. If there is such a bonus condition as determined at block 494, the routine may proceed to block 496 where a bonus round may be played. The bonus round may be a different game than slots, and many other types of bonus games could be provided. If the player wins the bonus round, or receives additional credits or points in the bonus round, a bonus value may be determined at block 498. A payout value corresponding to outcome of the slots game and/or the bonus round may be determined at block 500. At block 502, the player's cumulative value or number of credits may be updated by subtracting the bet made by the player and adding, if the slot game and/or bonus round was a winner, the payout value determined at block 500.

Although the above routine has been described as a virtual slot machine routine in which slot machine reels are represented as images on the display unit 69, actual slot machine reels that are capable of being spun may be utilized instead.

### Video Keno

FIG. 11 is an exemplary display 520 that may be shown on the display unit 69 during performance of the video keno routine 240 shown schematically in FIG. 4. Referring to FIG. 11, the display 520 may include a video image 522 of a plurality of numbers that were selected by the player prior to the start of a keno game and a video image 524 of a plurality of numbers randomly selected during the keno game. The randomly selected numbers may be displayed in a grid pattern.

To allow the player to control the play of the keno game, a plurality of player-selectable buttons may be displayed. The buttons may include a “Cash Out” button 526, a “See Pays” button 528, a “Bet One Credit” button 530, a “Bet Max Credits” button 532, a “Select Ticket” button 534, a “Select Number” button 536, and a “Play” button 538. The display 520 may also include an area 540 in which the number of remaining credits or value is displayed. If the display unit 69 is provided with a touch-sensitive or motion-sensitive screen, the buttons may form part of the video display 520. Alternatively, one or more of those buttons may be provided as part of a control panel that is provided separately from the display units 68, 69, 70.

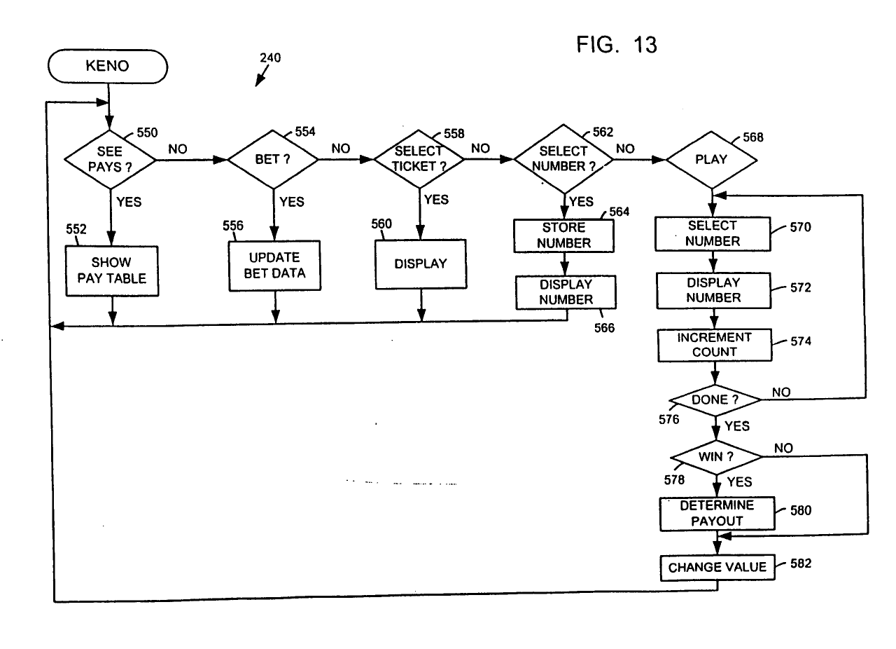

FIG. 13 is a flowchart of the video keno routine 240 shown schematically in FIG. 4. The keno routine 240 may be utilized in connection with a single gaming unit 20 where a single player is playing a keno game, or the keno routine 240 may be utilized in connection with multiple gaming units 20 where multiple players are playing a single keno game. In the latter case, one or more of the acts described below may be performed either by the controller 100 in each gaming unit or by one of the network computer 22, 32 to which multiple gaming units 20 are operatively connected.

Referring to FIG. 13, at block 550, the routine may determine whether the player has requested payout information, such as by activating the “See Pays” button 528, in which case at block 552 the routine may cause one or more pay tables to be displayed on the display unit 69. At block 554, the routine may determine whether the player has made a bet, such as by having pressed the “Bet One Credit” button 530 or the “Bet Max Credits” button 532, in which case at block 556 bet data corresponding to the bet made by the player may be stored in the memory of the controller 100. After the player has made a wager, at block 558 the player may select a keno ticket, and at block 560 the ticket may be displayed on the display 520. At block 562, the player may select one or more game numbers, which may be within a range set by the casino. After being selected, the player's game numbers may be stored in the memory of the controller 100 at block 564 and may be included in the image 522 on the display 520 at block 566. After a certain amount of time, the keno game may be closed to additional players (where a number of players are playing a single keno game using multiple gambling units 20).

If play of the keno game is to begin as determined at block 568, at block 570 a game number within a range set by the casino may be randomly selected either by the controller 100 or a central computer operatively connected to the controller, such as one of the network computers 22, 32. At block 572, the randomly selected game number may be displayed on the display unit 69 and the display units 69 of other gaming units 20 (if any) which are involved in the same keno game. At block 574, the controller 100 (or the central computer noted above) may increment a count which keeps track of how many game numbers have been selected at block 570.

At block 576, the controller 100 (or one of the network computers 22, 32) may determine whether a maximum number of game numbers within the range have been randomly selected. If not, another game number may be randomly selected at block 570. If the maximum number of game numbers has been selected, at block 578 the controller 100 (or a central computer) may determine whether there are a sufficient number of matches between the game numbers selected by the player and the game numbers selected at block 570 to cause the player to win. The number of matches may depend on how many numbers the player selected and the particular keno rules being used.

If there are a sufficient number of matches, a payout may be determined at block 580 to compensate the player for winning the game. The payout may depend on the number of matches between the game numbers selected by the player and the game numbers randomly selected at block 570. At block 582, the player's cumulative value or number of credits may be updated by subtracting the bet made by the player and adding, if the keno game was won, the payout value determined at block 580. The cumulative value or number of credits may also be displayed in the display area 540 (FIG. 11).

### Video Bingo

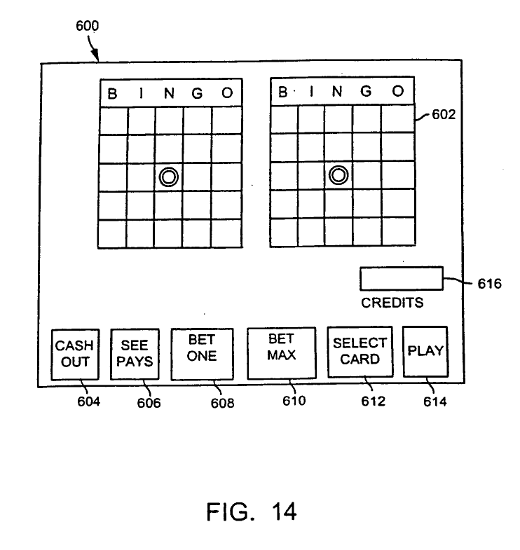

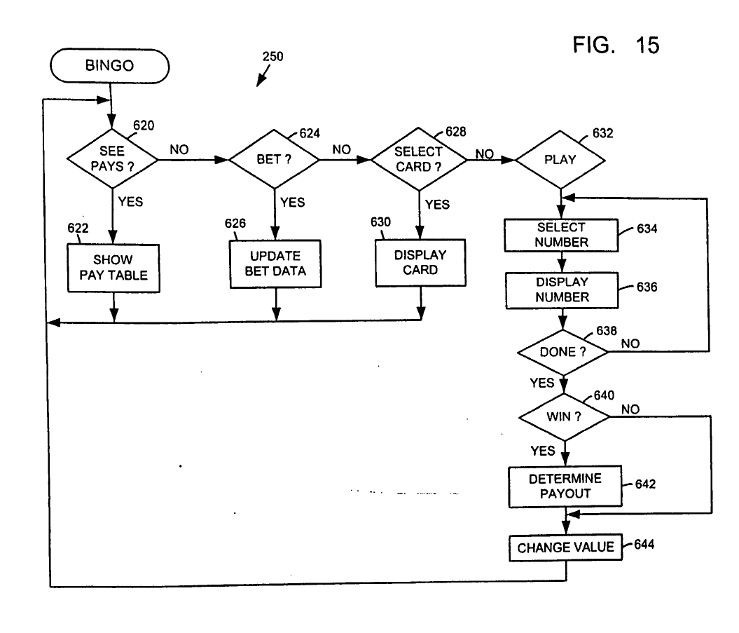

FIG. 14 is an exemplary display 600 that may be shown on the display unit 69 during performance of the video bingo routine 250 shown schematically in FIG. 4. Referring to FIG. 14, the display 600 may include one or more video images 602 of a bingo card and images of the bingo numbers selected during the game. The bingo card images 602 may have a grid pattern.

To allow the player to control the play of the bingo game, a plurality of player-selectable buttons may be displayed. The buttons may include a “Cash Out” button 604, a “See Pays” button 606, a “Bet One Credit” button 608, a “Bet Max Credits” button 610, a “Select Card” button 612, and a “Play” button 614. The display 600 may also include an area 616 in which the number of remaining credits or value is displayed. If the display unit 69 is provided with a touch-sensitive or motion-sensitive screen, the buttons may form part of the video display 600. Alternatively, one or more of those buttons may be provided as part of a control panel that is provided separately from the display units 68, 69, 70.

FIG. 15 is a flowchart of the video bingo routine 250 shown schematically in FIG. 4. The bingo routine 250 may be utilized in connection with a single gaming unit 20 where a single player is playing a bingo game, or the bingo routine 250 may be utilized in connection with multiple gaming units 20 where multiple players are playing a single bingo game. In the latter case, one or more of the acts described below may be performed either by the controller 100 in each gaming unit 20 or by one of the network computers 22, 32 to which multiple gaming units 20 are operatively connected.

Referring to FIG. 15, at block 620, the routine may determine whether the player has requested payout information, such as by activating the “See Pays” button 606, in which case at block 622 the routine may cause one or more pay tables to be displayed on the display unit 69. At block 624, the routine may determine whether the player has made a bet, such as by having pressed the “Bet One Credit” button 608 or the “Bet Max Credits” button 610, in which case at block 626 bet data corresponding to the bet made by the player may be stored in the memory of the controller 100.

After the player has made a wager, at block 628 the player may select a bingo card, which may be generated randomly. The player may select more than one bingo card, and there may be a maximum number of bingo cards that a player may select. After play is to commence as determined at block 632, at block 634 a bingo number may be randomly generated by the controller 100 or a central computer such as one of the network computers 22, 32. At block 636, the bingo number may be displayed on the display unit 69 and the display units 69 of any other gaming units 20 involved in the bingo game.

At block 638, the controller 100 (or a central computer) may determine whether any player has won the bingo game. If no player has won, another bingo number may be randomly selected at block 634. If any player has bingo as determined at block 638, the routine may determine at block 640 whether the player playing that gaming unit 20 was the winner. If so, at block 642 a payout for the player may be determined. The payout may depend on the number of random numbers that were drawn before there was a winner, the total number of winners (if there was more than one player), and the amount of money that was wagered on the game. At block 644, the player's cumulative value or number of credits may be updated by subtracting the bet made by the player and adding, if the bingo game was won, the payout value determined at block 642. The cumulative value or number of credits may also be displayed in the display area 616 (FIG. 14).

### Three-Dimensional Projection Display

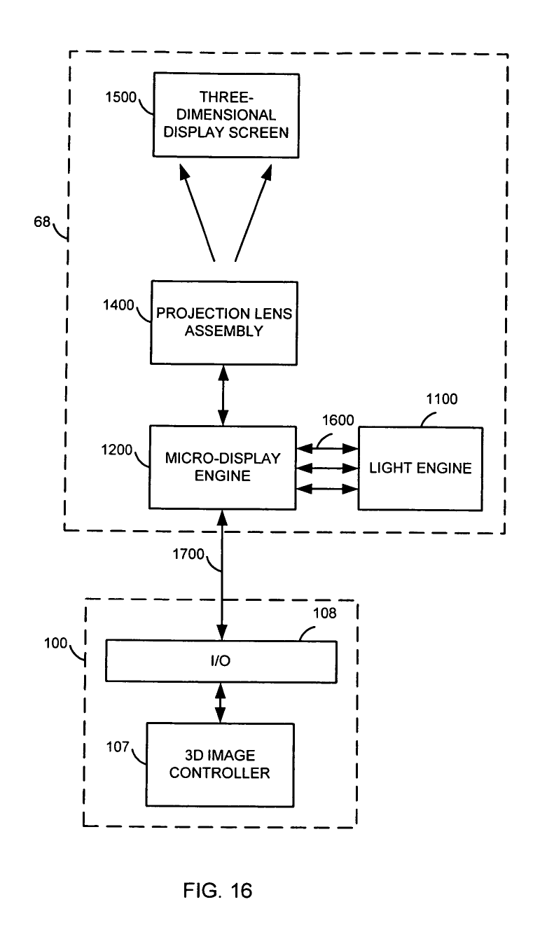

FIG. 16 is a block diagram of an exemplary depiction of a three-dimensional display unit 68 that may also be used in conjunction with or as an example of the three-dimensional display unit 69. Referring to FIG. 16, the three-dimensional display unit 68 may include a light engine 1100, a micro-display engine 1200 operatively coupled with the light engine 1100, a projection lens assembly 1400 operative coupled with the micro-display engine 1200 and which may be used to project images onto a three-dimensional display screen 1500. The light engine 1100 may be operatively coupled to the micro-display engine via one or more optical fibers 1600. The optical fibers 1600 may include three 1/2 inch optical fibers or other suitable optical waveguides. The three-dimensional image controller 107 may be operatively coupled to the micro-display engine 1200 via the I/O circuit 108 and one or more data cables 1700.

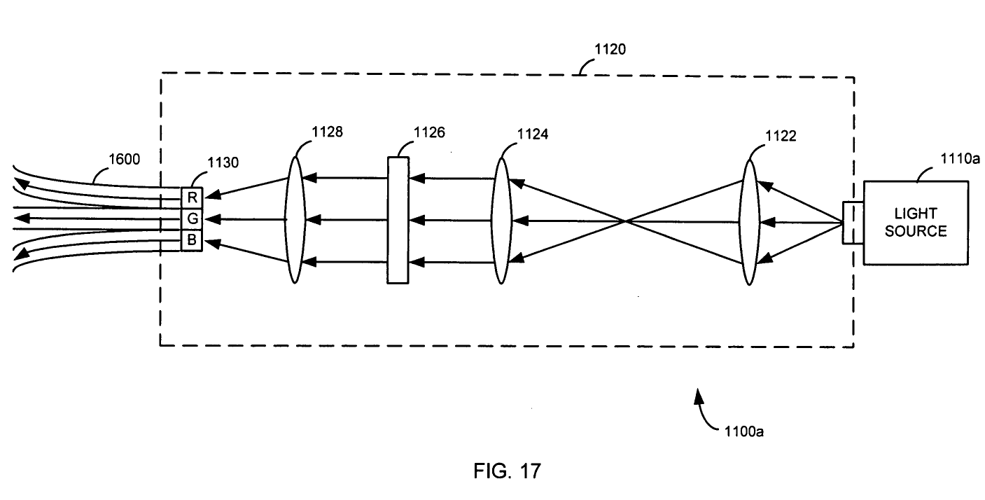

FIG. 17 is a block diagram of an exemplary depiction of a light engine 1100a, referred to above in connection with FIG. 16. Referring to FIG. 17, the light engine 1100a may include a light source 1110a and a fiber-optic pipe module 1120. The light source 1110a may include a halogen lamp, such as a 120 watt Ultra-High Performance (UHP) lamp providing approximately 600 lumens, or another light generator which may produce uniform white light. A 600 lumens light source 1110a for a reflective (rear projection) system may generally be considered bright enough to produce a three-dimensional image in combination with the three-dimensional display screen 1500 to attract players to the gaming unit 20, but not so bright as to cause strain and fatigue on a person's eyes. Depending on the size of the three-dimensional display screen 1500 or the number of light engines 1100a, different types of lamps with higher or lower light output may be used. For example, for a larger three-dimensional screen, multiple light engines or different projection system, different types of lamps with higher light output may be used. Transmissive (front-projection) systems, including projector systems sold by Epson under the trademark PowerLite, may use a brighter light source of around 180 W and around 1000 lumens.

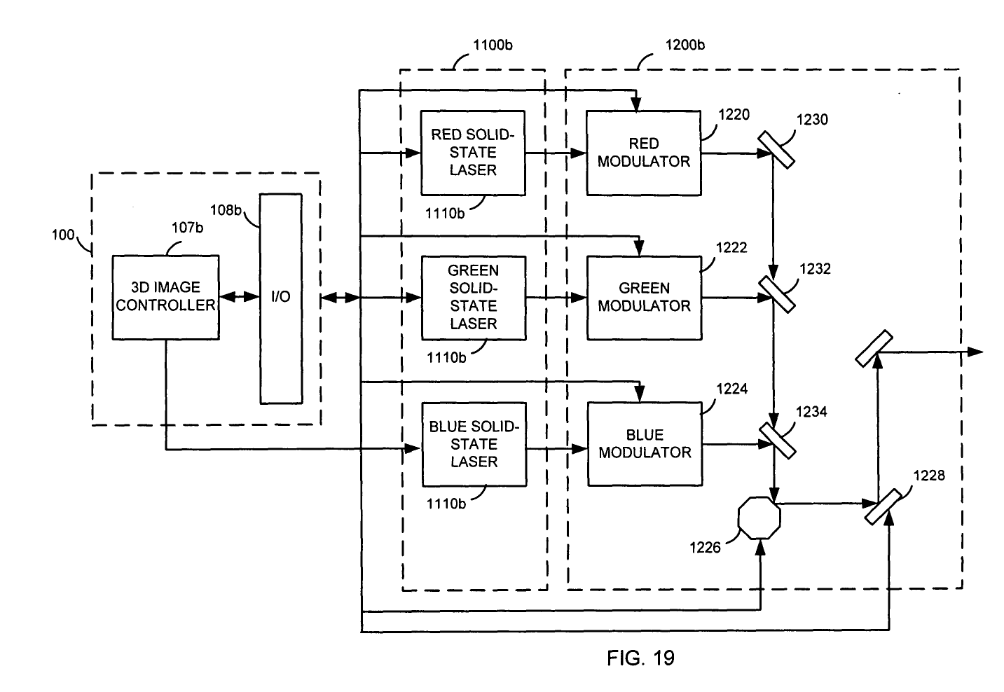

Lasers, including semiconductor laser diodes (i.e., solid state lasers), may also be used as the light source 1110b instead of a white light source as shown in FIG. 19, discussed further below. The lasers may produce light having a wavelength comparable to the three primary RGB (red, green, blue) colors used for color video. For example, one laser diode may produce light having a wavelength of approximately 630 nm (red), with another producing light at approximately 532 nm (green), and a third producing light at approximately 473 nm (blue). However, the RGB colors are not limited to any particular wavelength. Red may include any wavelength within the range of 600-650 nm, green may include any wavelength within the range of 500-550 nm, and blue may include any wavelength within the range of 440-490 nm. An example of a solid state laser system for producing RGB colors is further described in U.S. Pat. No. 5,317,348, which is hereby expressly incorporated by reference herein. However, other devices well known to those of ordinary skill in the art image projection may likewise be used as a light source 1110, such as one or more small, bright cathode ray tubes (CRT). A single CRT may provide the image. A grayscale CRT may be combined with a rapidly-rotating color filter wheel having red, green and blue filters to provide the RGB colors. Alternatively, three CRTs may be used, each one projecting a particular RGB color component of an image.

The fiber-optic pipe module 1120 may include an optical array of lenses and filters. The ends of the optical fibers 1600 may be tightly bundled into the fiber-optic pipe module 1120. A series of lenses 1122, 1124 may be included to collimate output light from the light source 1110a, though use of one or more solid state lasers as the light source 1110b may produce collimated light alone or with a waveguide formed on the laser diode without using the lenses 1122, 1124. One or more filters 1126 may provide infrared (IR) filtering which may be used to remove heat from the optical system. A fan may also be used to cool the optical system. One or more coupling lenses 1128 may couple the light onto the ends of the optical fibers 1600 to provide uniform illumination of the ends and to maximize transmission and minimize loss. However, light from a solid state laser may focus the light onto the optical fiber ends without the use of a coupling lens 1128.

Color filters 1130 may be provided on the ends of the three optical fibers 1600. Each of the color filters 1130 may correspond to one of the RGB colors to filter out all light except for the requisite color, such that one optical fiber 1600 streams red light, another optical fiber 1600 streams green light, and the third optical fiber 1600 streams blue light. For example, the red, green and blue filters 1130 may each filter out all wavelengths of light except for the corresponding bandwidths indicated above. If lasers are used that correspond to each of the RGB colors, the color filters 1130 may be used to refine the light to a particular wavelength, bandwidth or may bypassed altogether. The combination of lenses and filters may facilitate reduced reflection (i.e., reduced light loss). Each of the lenses 1122, 1124, 1128 and filters 1126, 1130 may be selected to maximize the wavelength (band-pass) for each RGB color.

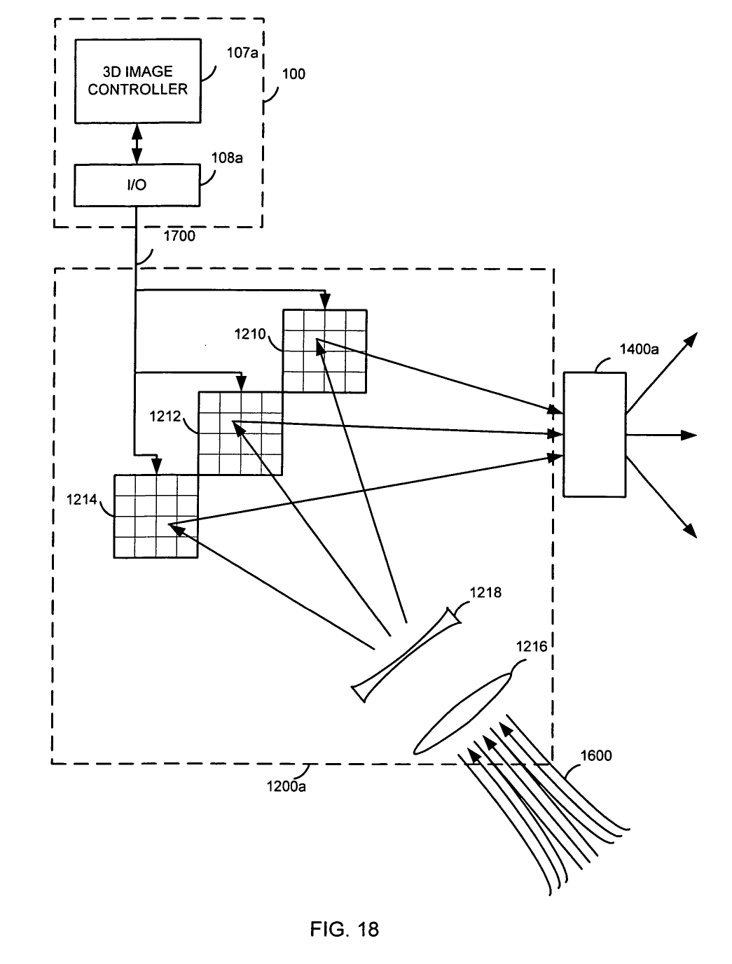

FIG. 18 is a block diagram of an exemplary depiction of a micro-display engine 1200a and projection lens assembly 1400a referred to above in connection with FIG. 16. Referring to FIG. 18, the three optical fibers 1600 may be used to direct the RBG color streams into the micro-display engine 1200a, which may be located several feet away from the light engine 1100. The light engine 1100 may thus be installed in the best position within the gaming unit 20 to maximize heat exchange. Alternatively, the micro-display engine 1200a and the light engine 1100 may be provided together, as in a standard video projector. The micro-display engine 1200a may include three LCoS (liquid-crystal-on-silicon) micro-display modules 1210, 1212, 1214, one for each of the primary RGB colors. LCoS micro-display modules 1210, 1212, 1214 may further provide maximum brightness, contrast and quality over other techniques. LCoS micro-display modules 1210, 1212, 1214 are generally liquid crystal displays (LCDs) light valves mounted on a silicon backplane, such as a complementary metal-oxide-semiconductor (CMOS) silicon backplane. Other types of micro-display modules 1210, 1212, 1214 may also be used, including micro-electro-mechanical systems (MEMS) involving digital micro-mirror devices (DMDs), also known as digital light processors (DLPs), or grating light valves (GLV). A single semiconductor chip in combination with a color wheel or a color semiconductor chip (i.e., RGB colors all on the same semiconductor chip) may also be used.

Each micro-display module 1210, 1212, 1214 may include a logic and control to drive the micro-display engine 1200a. While the three-dimensional display unit 68 may utilize transmissive projection, the described example will be primarily explained with reference to reflective projection. Those of ordinary skill in the art of image projection will readily understand how to implement a transmissive projection system in place of the reflective projection system described below.

Using a reflective projection system, each micro-display module 1210, 1212, 1214 may include an array of reflective cells or pixels. Each cell may have an address, which may be identified by a row and column addressing scheme, with the total number of cells or pixels in each micro-display module 1210, 1212, 1214 matching a selected resolution (for example 640×480, 800×600, 1024×768, 1280×720, 1920×1080, etc.) or which otherwise supports various resolution types (e.g., SXGA, UXGA, VGA, XGA). The degree of reflectivity of each cell may be controlled by a polarization factor associated with each LCD light valve to cause the cell to be either “on” or “off”, though the degree of reflectivity may be variable over this range. The LCD light valve may, in turn, be controlled by voltages applied by the CMOS silicon backplane, which may essentially comprise an active matrix. When at the highest degree of reflectivity (i.e., at the white level), 90 to 95% of the incident light may be reflected by the cell. At the lowest degree of reflectivity (i.e., at the black level), 5 to 10% of the incident light may be reflected by the cell. Lower degrees of reflectivity for the black level may improve the contrast of the display, which may improve image quality. A contrast ratio of 400:1 may generally be acceptable, though increased or decreased contrast ratios may be used depending on the brightness of the ambient light. Increasing the degree of reflectivity for the white level may improve the brightness of the image produced by each cell. The overall brightness may also be determined by output of the light engine 1100 (e.g., brighter light source 1110a), as referenced above.

A color data bit stream may be converted to voltages for the active matrix to determine the polarization factor of the cell, and hence the degree of reflectivity. Using 8 bits of color data per micro-display module 1210, 1212, 1214 provides 24 bits or over 16 million color combinations. The color data bit stream may be provided by a three-dimensional controller 107a adapted to transmit signals suitable for controlling the micro-display modules 1210, 1212, 1214. The type of three-dimensional controller 107 and/or the format of the data sent to the micro-display engine 1200 may be dependent on the particular display technology being used with the display engine 1200, as would be well known to those of ordinary skill in the art. The color data bit stream may be transmitted to the micro-display engine using the data cable 1700. A micro-display controller may be provided with the micro-display modules as a frame buffer, timing generator, and as a digital-to-analog converter, similar to a micro-display controller used to drive a standard reflective projection system.

The color streams as transmitted by the optical fibers 1600 may be directed at the surface of the micro-display modules 1210, 1212, 1214, with the red color stream directed at one micro-display module 1210, the green color stream directed at a second micro-display module 1212 and the blue color stream directed at a third micro-display module 1214. When the color streams are incident on the surface of a micro-display module 1210, 1212, 1214, the light reflects off the “on” cells towards a projection lens assembly 1400a. The type or composition of the projection lens assembly 1400 may be dependent on the particular display technology being used with the micro-display engine 1200, as understood by those of ordinary skill in the art. The individual cells may be selected to be “on” or “off” using the color data stream from the three-dimensional controller 107a and the CMOS silicon backplane. For example, if pixel 1, line 1 is to be red, the cell at row 1, column 1 of the red micro-display module 1210 may be set to “on” whereas the cells at row 1, column 1 of the green and blue micro-display modules 1212, 1214 are set to “off”. The brightness of the color reflected by the “on” cell may also be controlled using brightness data streams from the three-dimensional controller 107a and the CMOS silicon backplane by varying the reflectivity of the cell. The reflected light from all three micro-display modules 1210, 1212, 1214 may be directed to the projector lens assembly 1400a for projection onto the three-dimensional display screen 1500. Additional lenses 1216, 1218 may be provided at the end of the optical fibers 1600 depending on the transmission distance and the numerical apertures.

FIG. 19 is a block diagram of an alternative exemplary depiction of a micro-engine display 1200b in cooperation with a light engine 1100b and a three-dimensional controller 107b. As mentioned above, the light engine 1100 for the three-dimensional display unit 68 may use three solid-state lasers as the light source 1110b, one for each of the RGB colors. A micro-display engine 1200b in conjunction with solid state laser light sources 1110b may include laser modulators 1220, 1222, 1224, a polygonal mirror 1226 for horizontal timing, and a galvanometer scanning mirror mechanism 1228 for vertical timing to project the three-dimensional image. Alternative scanning mirrors may be utilized in place of the polygonal mirror 1226 and the galvanometer scanning mirror 1228. Referring to FIG. 19, each color laser modulator 1220, 1222, 1224 may receive a video data stream from a three-dimensional image controller 107a via the data cable 1700 and modulate the intensity of the light beam. All three color streams may be directed to the polygon mirror 1226 and the galvanometer scanning mirror 1228 via mirrors 1230, 1232, 1234. The mirrors 1230, 1232, 1234 may generally reflect one wavelength or bandwidth while passing another. For example, the mirror 1232 for the green color stream may reflect the wavelength(s) for the green color while transmitting the reflected red color stream. Likewise, the mirror 1234 for the blue stream may reflect blue, but transmit red and green. The polygon mirror 1226 and the galvanometer scanning mirror 1228 provide the horizontal and vertical timing to the light stream, thereby providing the image. A laser-based light engine 1100b and micro-display engine 1200a may improve any focusing issues due to large z-axis variations, provided the laser-generated light remains coherent. The choice between a coherent, laser-based three-dimensional display unit 68 and a incoherent, halogen-based three-dimensional display unit 68 may depend on the size of the gaming unit 20, the design of the three-dimensional display screen 1500 and cost. Though reference may be made to the micro-display modules 1210, 1212, 1214 herein, those of ordinary skill in the art will readily understand how to implement any modifications necessary to utilize modulators 1220, 1222, 1224, a polygon mirror 1226 and a galvanometer scanning mirror 1228 in place of the micro-display modules 1210, 1212, 1214.

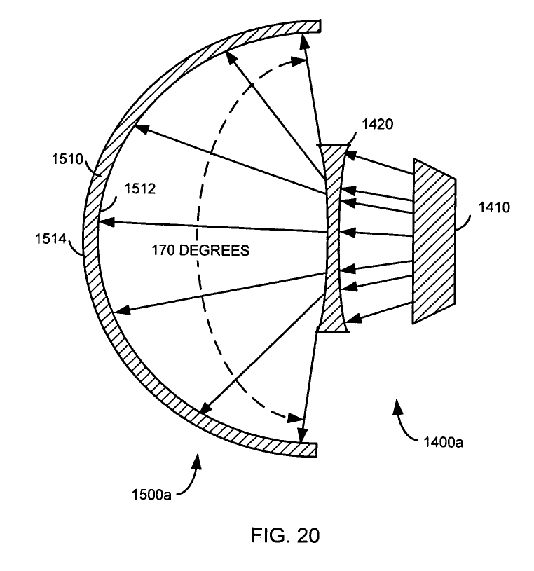

FIG. 20 is a cross-sectional view of a side of an exemplary depiction of a three-dimensional display screen 1500a in conjunction with an exemplary depiction of a projection lens assembly 1400a, both referred to above in connection with FIG. 16. Referring to FIG. 20, the projector lens assembly 1400a may be an ultra-wide lens or lens assembly. An ultra-wide lens system may provide a wide field of view. As discussed further below, a 170-degree field of view closely matches the geometry of a hemisphere. Although an ultra-wide lens may have lateral secondary color aberrations, an optical correction technique, discussed further below, may correct for such aberrations. Other types of lens systems may be used depending on the design of the three dimensional display screen 1500. For example, complex three-dimensional screen designs could use multiple projection lens assemblies 1400 and multiple micro-display engines 1200 to project the different portions of an image onto the various surfaces of a three-dimensional display screen 1500 such that each surface is in the line of sight of at least one of the image projections from a projection lens assembly 1400. Some three dimensional display screen 1500 designs combined with shallow cabinets may use primary surface mirrors.

The projector lens assembly 1400a may include a projector lens 1410 to focus the image from the micro-display engine 1200 onto a wide-angle lens 1420. The image from the wide-angle lens 1420 may then be projected onto the inner surface 1512 of the three-dimensional display screen 1500, which in this example is in the shape of a dome 1510 as shown in FIG. 2 with the top-box three-dimensional display unit 68. Alternative projector lens assemblies 1400 may be found in U.S. Pat. Nos. 5,762,413 and 6,231,189, which are expressly incorporated by reference herein. The dome 1510 in this example may adequately accept a projected image having a 180 degree field of view, which would cover the entire inner surface 1512 of the dome 1510. However, a projected image having a slightly larger or smaller field of view, such as a 170 degree field of view as shown in FIG. 20, may also be adequate. The field of view for a dome may likewise increase or decrease from 180 degrees, though more than one projector lens system 1400, micro-display engine 1200 and/or light engine 1100 may be needed if the wide angle lens 1420 is unable to project the image more than 180 degrees.

In order to adequately project the image onto the non-planar surface of the dome 1510, the image stream from the projector lens assembly 1400a may be aligned to be in the line of sight of the surface to be projected. For example, to project the image of the right side of an image onto a surface of a three-dimensional display screen 1500 that forms the right side of the image, the surface of the right side may be within the line of sight of the right side of the projected image. For a simple three-dimensional display screen 1500 design, such as the dome 1510, the entire inner surface 1512 may generally be in the light of sight of a single projection lens assembly 1400a. However, with more complex three-dimensional display screen 1500 designs, such as the generic face mentioned below, several projection lens assemblies 1400, micro-display engines 1200 and/or light engines 1100 to be used to project various images of an overall image onto the various surfaces of the three-dimensional display screen 1500. For example, the images of the right and left sides of a nose may not adequately be in the line of sight of a single projection lens assembly 1400. Left, right, upper, lower and center views may therefore be projected by corresponding projection lens assemblies 1400 that are in the line of sight of the left, right, upper, lower and center views. More or fewer projection lens assemblies 1400 and more or fewer views may be used as needed.

Folds or extrusions within the formed three-dimensional display screen 1500 may not be desirable because there may not be a line of sight from any position for a projection lens assembly 1400, though these parts of the three-dimensional display screen 1500 may include static, non-video images to provide continuity and integrity to the overall image viewed by the player. In the example of a human face, this may include the interior of the nostrils, the interior of the ear, folds in the ear, etc. which could be painted onto those portions of the generic human face. A similar solution may be used if the lens 1420 used to project the image onto the inner surface 1512 does not have a wide enough angle. For the dome 1510 of FIG. 20, a hemisphere has 180 degrees of surface relative to the projector assembly 1400a, though the projecting lens 1420 has a 170 degree viewing angle. Therefore, the edge of the dome 1510 may be painted or covered to hide the unprojected portion extending in 5 degrees from the edge of the dome 1510. If the edge of the dome 1510 where to be extended further so as to require a field of view greater than 180 degrees (i.e. decrease the diameter of the opening while increasing the interior surface area), a fold would be created which may make it more difficult to project an image. It may be desirable to project an image having an area larger than the area of the viewing surface of the three-dimensional display screen 1500. Those parts of the image being projected beyond the viewing surface may be set to black to avoid undesirable reflections.

The three-dimensional display screen 1500 may be made from flexible rear projection screen material as may be found with rear projection imaging technology. The material for the three-dimensional display screen 1500 may be amenable to cutting, bending, molding and forming various three-dimensional shapes of various sizes. Examples of such materials include various optical polymers including an optical polymer sold by Lumin-oZ under the trademark “Revolution”, which is capable of being vacuum formed into various three-dimensional shapes and sizes. In the instant example, the three-dimensional display screen 1500a is in the shape of a hemisphere or dome 1510.

Using rear projection screen material or an optical polymer as mentioned above, may generally be applicable to rear projection systems in which a image may be projected on the inner surface 1512 of the three-dimensional screen and viewed from an outer surface 1514. That is, the image still reflects off the rear or inner surface 1512 of the three-dimensional screen, but the screen material is transmissive to allow the viewer to see the image from the front or outer surface 1514. In an alternative example, a transmissive (front) projection system may be used to also project the three-dimensional image onto the inner surface 1512 of the three-dimensional display screen 1500, although the image may be viewed from the inner surface 1512. In the latter example, the material for the three-dimensional display screen 1500 may likewise be amenable to cutting, bending, molding and forming various three-dimensional shapes of various sizes, though the image would primarily reflect off the inner surface 1512 of the three-dimensional display screen 1500 for viewing on the inner surface 1512 rather than being partially transmitted through the material for viewing on the outer surface 1514. While the various other components and techniques described above and below may remain applicable to this example, a reflective micro-display engine 1200a may be replaced with a transmissive or transmittive micro-display engine as found with projectors such as a PowerLite projector referred to above. An example of a front projection system may further be found in U.S. Pat. No. 6,530,667, which is expressly incorporated by reference herein. An example of a three-dimensional display screen 1500 which may be used in conjunction with a front projection system may also be found in U.S. Pat. No. 6,530,667, referred to above, and in U.S. Design Pat. Nos. 440,794 and 436,469, which are expressly incorporated by reference herein. In one example, a transmissive three-dimensional display unit may be large enough to incorporate an entire person. That is, a three-dimensional display screen 1500a and non-planar, three-dimensional image may envelop the player's entire field of view when looking forward at the center of the inner surface 1512. Infrared sensors, or other sensors, may be used to track the player's eye movements and change the image accordingly to continually fill the player's field of view. An example of possible sizes includes a three-dimensional display screen 1500 in the shape of a dome having a diameter in the range of about 144-163 centimeters with a radius of curvature of about 53-84 centimeters. Even larger three-dimensional display screens 1500 may be used for multiple people.

As mentioned above, the three-dimensional display screen 1500 may be of any shape and size, though the dome 1510 is used as an example for ease of explanation. However, other examples of the three-dimensional display screen 1500 may include a three-dimensional display screen 1500 vacuum-formed into a three-dimensional representation of a generic human face. While the techniques below are described in relation to projecting a non-planar, three-dimensional facial image onto a non-planar, three-dimensional display screen 1500 in the shape of a human face, these techniques are also applicable to any other three-dimensional image and three-dimensional display screen 1500 shape.

A human face or any other desired form for the three-dimensional display screen 1500 may be designed using sculpturing techniques, three-dimensional computer aided design, etc. A three-dimensional computer aided design (CAD) computer program may use polygonal mesh algorithms to generate a three-dimensional image for designing the three-dimensional display screen 1500. A mold may then be created from such a design and the same polygonal meshes may be used for generating a three-dimensional video image to be displayed on the three-dimensional display screen 1500. Use of these techniques and others in association with the above-mentioned vacuum formation are well known to those of ordinary skill in the art. A three-dimensional image of a real or virtual human face may then be projected onto the three-dimensional generic face from the projection lens assembly 1400 to add details to the face. While the entire face may be subject to animation, if only certain aspects of the face, such as the mouth and eyes, are subject to animation, the degree of animated detail may be minimized by adding a static image, which may be either a video or non-video image, for the non-animated portions.

The three-dimensional display screen 1500 may be used to replace the top-box display, the belly glass display, and/or the main player display. For example, with the bonus games and attraction sequences described above, the three-dimensional display unit 68 may be used to replace the top-box. A three-dimensional display screen 1500 in the shape of a half-cylinder may be used as the main player display, as shown with the three-dimensional display unit 69 in FIG. 2. For example, mechanical spinning slot machine reels or two-dimensional video slot machine reels that appear to spin may be replaced with the three-dimensional cylinder. Three-dimensional images may be projected onto the cylinder to imitate spinning slot machine reels during game play. The appearance and number of slot machine reels may be easily changed using different images, or replaced entirely with various images as part of an attraction sequence. Any of the visual displays described above with FIGS. 8, 9, 12, 13 and 14 may also be displayed on one or more of the three-dimensional display screens 1500 which may be of various shapes and sizes. For example, card games may display cards on a three-dimensional display screen 1500 in the shape of a half-cylinder, with the player-selectable buttons and credits displayed on another three-dimensional display screen 1500 or a two-dimensional display.

Additional three-dimensional display screen 1500 shapes include a sphere, an annulus, a disc, etc. A sphere or dome 1510 may have a three-dimensional image of a spinning sphere displayed thereon. The three-dimensional image of the sphere may be made up of multiple triangles or wedges, each of which may be associated with a number, symbol, color, etc. A bonus game may include causing the image of the sphere to appear to spin randomly in various directions. A random number generator may determine when the image of the sphere stops spinning, at which time one of the triangles or wedges directly facing the player, placed in the center of the three-dimensional display screen 1500, or in any other predetermined area. The player may receive a payout depending on the triangle or wedge within the predetermined area. When the gaming unit 20 is not in use, the three-dimensional display screen 1500 may display an image of the sphere spinning, display movies, display animation, display advertisements, display an attraction sequence, display casino information, display game information, display game instructions, etc. With a player tracking system, the images may be tailored to the player's preferences.

A three-dimensional display screen 1500 in the shape of an annulus or a disc may display multiple three-dimensional spinning wheels around the annulus or around the edge of the disc. Each wheel may be spun independently and at different speeds as part of a bonus game or as part of an attraction sequence. An additional three-dimensional image may be displayed in the center of the annulus or disc, which may be another wheel, a movie, an animation, etc.

The non-planar three-dimensional images may be developed specifically for the three dimensional screen 1500 from the polygonal meshes used for designing and building three-dimensional display screens 1500. For example, a three-dimensional image of a face may be created using the three-dimensional computer data initially used to create the mold for the three-dimensional display screen 1500 in the shape of a generic face, by scanning a three-dimensional sculpture of the display screen 1500, or by scanning the three-dimensional display screen 1500 itself. The three-dimensional images may be rendered using standard rendering techniques such as the OpenGL® graphics language. While OpenGL® is well-known to those of ordinary skill in the art of three-dimensional animation, an explanation of OpenGL® may be found in the publication entitled “OpenGL® Programming Guide,” 3^{rd} Ed., v.1.2, ISBN 0-201-60458-2, the contents of which are expressly incorporated by reference herein. Other three-dimensional images may be designed and developed independently of the polygon meshes used to design and build the three-dimensional display screen 1500, using standard three-dimensional computer aided design software for three-dimensional image creation and rendering. While such computer software programs have been used to display virtual three-dimensional images on a planar, two-dimensional screen, the planar three-dimensional image data used to create the virtual three-dimensional image may be also be used with the three-dimensional display screen 1500.

A three-dimensional image created on a computer may generally include data describing the image in three-dimensions. Using multiple projectors lens assemblies 1400 and/or multiple micro-display engines 1200, each may display a particular view (e.g., left, right, upper, lower and center views) of the three-dimensional image. For example, the left view of a three-dimensional facial image, regardless of the orientation of the face, may be routed to a projector that displays that portion of the three-dimensional image on the left side of the three-dimensional display. Because the data may describe the image in three dimensions, the data may be readily available for each view. The overall video image may thereby comprise the several different views all being displayed simultaneously by each projection lens assembly 1400 and micro-display engine 1200. Each frame of the overall video image may then include several frames, each corresponding to a different view. To create each frame for each view, the three-dimensional image of each frame may be “flattened” prior to rendering to create a two-dimensional image for each view. The overall video image may thereby be converted into a two-dimensional video source. The rendering process may then add shading, texture, etc. resulting in a planar, two-dimensional image for each view. This process may be performed for each frame and for each view. Alternatively, because the planar three-dimensional image data of a virtual three-dimensional image describes the object of the image in three dimensions, the planar three-dimensional image data itself may be used without flattening to display the various views. Each view, whether flattened or unflattened, may be projected onto the corresponding surface of the three-dimensional display screen 1500.

Non-planar displays, such as the three-dimensional display screen 1500, may cause brightness and image distortions when displaying a planar image, in addition to lateral secondary color aberrations from ultra-wide lenses in the projection lens assembly 1400. However, an image may be projected onto a non-planar, three-dimensional display screen 1500 with little or no distortion using a correction technique described further below. For example, the image data for each planar, three-dimensional image may be sent as two-dimensional image data. In the case of multiple views, each view may be sent as two-dimensional data for the corresponding view. The correction technique may be used to correct for any distortions from displaying a planar, two-dimensional image on a non-planar, three dimensional display screen 1500. The data describing the image in three-dimensions may be used by the correction technique to adjust the planar image for distortions when projected onto the surface of the three-dimensional display screen 1500. In the case of planar three-dimensional image data, whether “flattened” or “unflattened” as described above, the correction technique may be used to correct for optical aberrations (e.g., distortions), but may not be needed to correct for other distortion effects. For three-dimensional images designed specifically for the three-dimensional display screen 1500, most of the corrections may be incorporated into the three-dimensional image data itself, though the correction technique may still be used to correct for some distortion effects, such as brightness distortion and color aberrations.

### Correction Technique

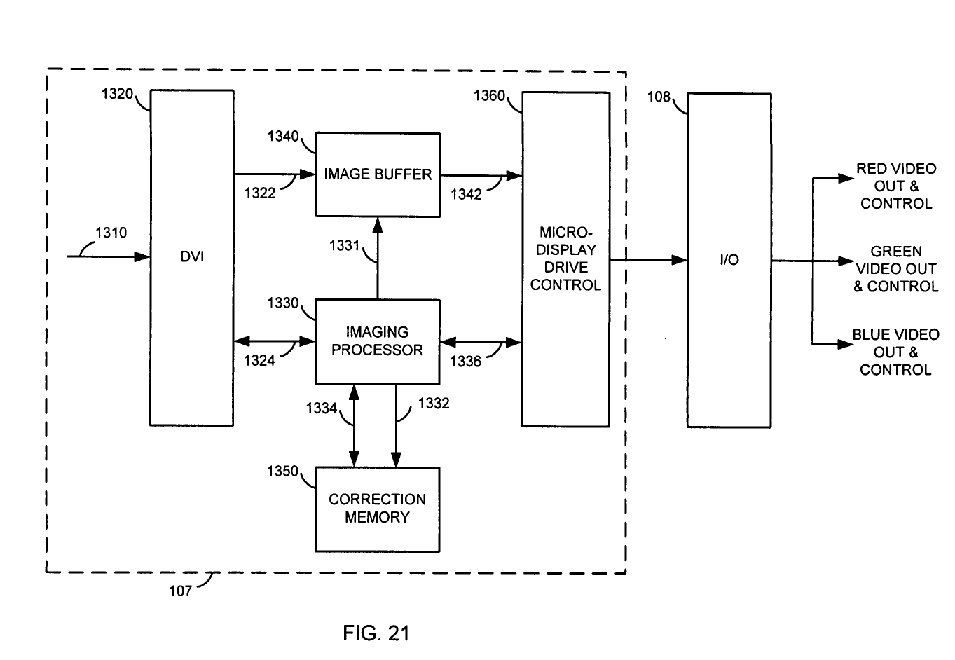

FIG. 21 is a block diagram of an exemplary depiction of a three-dimensional image controller 107 referred to above in connection with FIG. 16. Referring to FIG. 21, the three-dimensional image controller 107 may be an interface board operatively coupled to the micro-display engine 1200 via the I/O circuit 108. Alternatively, the three-dimensional image controller 107 may be provided separately from the controller 100 with a video output of the controller 100, which may be an output from the I/O circuit 108, providing the two-dimensional video input to the three-dimensional controller 107.

The three-dimensional image controller 107 may provide an image and signal conversion to receive a two-dimensional video input 1310, which may be a digital or analog video input, and modify the two-dimensional video input 1310 to be displayable as a three-dimensional video image. The two-dimensional video input 1310 may be any two-dimensional video source of the type normally used for standard planar, two-dimensional screen monitors including cathode ray tube monitors, projection television monitors, flat screen monitors, etc. The two-dimensional video input 1310 may be designed to provide a projected light gain towards the front of a standard planar, two-dimensional screen monitor to maximize brightness for a person positioned directly in front of the monitor (i.e., small viewing angle). The three-dimensional image controller 107 may provide signal conversion, translation and correction to correct for diminished brightness that may occur when a two-dimensional video signal 1310 is projected onto portions of a non-planar, three-dimensional display screen 1500. For example, when viewing a video image at an angle, the brightness may be diminished. This may often occur with projection display systems. For a non-planar, three-dimensional display screen 1500, portions of the display (e.g., the right side) may be at an angle to the player causing diminished brightness as compared to other portions (e.g., the front) of the display. In other words, curved or angled surfaces may increase the viewing angle the images displayed on those surfaces and the player viewing the images. The three-dimensional image controller 107 may also correct for image distortion that may occur when a two-dimensional video signal 1310 is projected onto the three-dimensional display screen 1500. For example, geometric image distortion may occur when projecting a square pixel onto a curved surface. The square pixel may be viewed as a rectangle or irregular polygon on such a curved surface. Variations in brightness may also occur with the distorted pixel because brightness is maximized in a two-dimensional video signal 1310 for small viewing angles. Likewise, the three-dimensional image controller 107 may correct for lateral secondary color aberrations that may occur due to an ultra-wide angle lens. In the case of a three-dimensional image data described above, the three-dimensional controller 107 may only need to correct for distortions from lateral secondary color aberrations and brightness distortions.

The three-dimensional image controller 107 may include a digital video interface (DVI) 1320, an imaging processor 1330 operatively coupled to the digital video interface 1320, an image buffer 1340 operatively coupled to the digital video interface 1320 and the imaging processor 1330, a correction memory 1350 operatively coupled to the imaging processor 1330, and a micro-display drive control 1360 operatively coupled to the imaging processor 1330 and the image buffer 1340. While RGB analog video signals may be used as a two-dimensional input video signal in conjunction with an analog-to-digital converter, the two-dimensional input video signal 1310 may be a digital signal. Alternatively, three-dimensional image data designed for the three-dimensional screen 1500, and planar three-dimensional image data (e.g., virtual three-dimensional image data) may be used as the input video signal. Though the following description will primarily discuss the three-dimensional image controller 107 and its functions with respect to a two-dimensional image input video signal 1310, those of ordinary skill in the art will recognize how the three-dimensional image controller 107 may be applied to a three-dimensional input video signal (e.g., correction for color aberrations).

The digital video interface 1320 connection may be used to receive the digital two-dimensional input video signal 1310 and avoid having to use an analog-to-digital converter. The digital video interface 1320 may include a transition minimized differential signaling (TMDS) receiver at the front end to convert RGB data and clock serial streams from the two-dimensional input video signal 1310 into 24-bit parallel video data 1322 and into control data and frame clock (timing) signals 1324. The digital video interface 1320 may convert the input video signal 1310 into other video data 1322 formats, including 32-bit parallel video data 1322, depending on the resolution of the video image. The video data 1322 may be sent to the image buffer 1340, whereas the control data and frame clock signals 1324 may be sent to the imaging processor 1330.

The imaging processor 1330 may receive the control data and frame clock signals 1324 to maintain the location of each pixel data (i.e., maintain the display address of each pixel). For example, two-dimensional input video data 1310 may have a video resolution of 800×600 pixels with a vertical video retrace rate of 85 Hz (85 frames per second) giving a total of 480,000 pixels per frame and 40.8 million pixels per second. However, the horizontal frequency may be anywhere within the range of 15-92 Hz and the vertical frequency may be within the range of 50-96 Hz. Other video resolutions are also possible, as mentioned above, and may depend on the size of the three-dimensional display screen 1500. A large video image may use a higher degree of resolution to provide a more detailed image such that each pixel of the image may be less pronounced than with lower resolution images on the same three-dimensional display screen 1500. Vertical and horizontal retrace signals may control the position of the top horizontal line of the image (i.e., line 1) and the position of the first displayable pixel (i.e., pixel 1) of each line within a given frame. A pixel control clock may maintain the count of the displayed pixels. The imaging processor 1330, however, may assign a pixel image to any designated position or address on the three-dimensional display screen 1500, even though the two-dimensional input video data 1310 may display a video pixel stream sequentially from left to right and top to bottom for each frame. While this may be relatively simple for displaying a video image through a micro-display engine 1200 having identical resolutions, for differences in resolution (e.g., 800×600 video image on a 1280×1024 pixel screen) the address maintenance may become more pronounced.

The imaging processor 1330 may also control the received pixel data to be stored in the image buffer 1340. The 24-bit video data 1322 may be sent directly from the digital video interface 1320 to the image buffer 1340, and the imaging processor 1330 may provide multiplexing timing for this process by way of timing and control signals 1324, and addressing and control signals 1331. For example, each piece of pixel data in the 24-bit video data 1322 may be associated with three bytes of data to provide 24-bits of color, which equates to 1.44 MB to be stored for a single image frame. The image buffer 1340 may therefore be a 24-bit wide, 1.44 M memory, though the width and size of the image buffer 1340 may vary depending on the characteristics of the video data 1322 and overall resolution. In one example, the image buffer may be 32-bits wide and 16 MB large to allow for 32-bit video data 1322. The image buffer 1330 may further be a constant rotating and sequential buffer, such that for every frame of video data 1322, pixel data may be refreshed with new pixel data for each subsequent frame.

The imaging processor 1330 may correct the displayable pixel by retrieving correction data from the correction memory 1350 using timing signals 1332. The correction memory 1350 may be non-volatile memory such as flash memory, such that the correction memory 1350 may only be changed or updated if the three-dimensional image is changed. As mentioned above, a two-dimensional video image displayed on a three-dimensional display screen 1500 may include some distortions with some of the pixel images. The correction memory 1350 may therefore store correction codes 1334 to correct for the distortion effects. In one example, the correction memory 1350 may contain a 32-bit correction code 1334 for each 4×4 pixel block stored in the image buffer 1340. An example of a 4×4 pixel block may be the first 4 pixels on horizontal line 1, the first 4 pixels on line 2, the first 4 pixels on line 3 and the first 4 pixels on line 4. For the first 4 horizontal lines of a 800×600 resolution image there may be a total of 200 correction codes 1334, with a total of 30,000 pixel blocks, and hence 30,000 codes 1334, for the 480,000 pixels of a 800×600 resolution image. The correction codes may comprise a 200×150 matrix to match the array of 4×4 pixels in a 800×600 image. The size of the pixel blocks and/or the number of codes 1334 may vary depending on the image resolution, different three-dimensional display screen 1500 resolutions, the size of the three-dimensional display screen 1500, etc.

Each correction code may contain offset and correction values, a brightness value (degree of cell reflectivity) and correction data related to a ray analysis. The offset and correction values and brightness values may be developed from the original three-dimensional data used to design the three-dimensional display screen 1500. This may help avoid duplicative scanning processes and further help to maintain accuracy in correcting the input video signal for display on the three-dimensional display screen 1500, though a scan of the three-dimensional display screen 1500 may also provide this data. By using information about the three-dimensional display screen 1500, the effects on the image may be predicted (e.g., predict image distortion and brightness changes) and correction codes may be developed accordingly. The offset and correction values may generally relate to the position and shape/size of a pixel image. For example, an offset value may be used to avoid projecting a pixel image of an ear where a pixel image of a cheek should be displayed. The correction value may be used to increase or decrease the size of the pixel image, or even elongate or shorten an aspect of the pixel image. As an example, a pixel image of a left ear generally looks smaller from the front than from the left (i.e., a person sees more of the left ear when viewing from the left). Using a two-dimensional input video signal 1310 of a frontal view of a face with a micro-display engine 1200 for displaying only the left side of the face would require elongation of the pixel images associated with the left side of the frontal view, while shortening or eliminating those pixel images associated with the front or right side of the frontal view.

The corrected brightness data may be control data that varies the degree of reflectivity of each cell. As explained above, each cell may vary its degree of reflectivity through control voltages. Based on the surface curvatures of the three-dimensional display screen 1500, the imaging processor 1330 may provide an appropriate increase or decrease in the brightness control signal to provide a higher or lesser degree of brightness to compensate for variations in the viewing angle. For example, for those pixels that may be displayed on the side of a nose, the viewing angle may be increased for a person facing the three-dimensional display screen 1500. Therefore, predetermined control data may increase the degree of brightness for all pixel images to be projected on that portion of the three-dimensional display screen 1500. Likewise, the brightness control data may decrease the brightness for those pixel blocks having a small viewing angle relative to the person. The brightness may vary depending on the particular color being displayed. For example, if the displayed color of a particular pixel is red, the cell(s) of the micro-display module 1210 corresponding to red and corresponding to the display position of the pixel may receive the corrected brightness data, whereas the corresponding cell(s) of the remaining micro-display modules 1212, 1214 may not receive the corrected brightness data because they correspond to green and blue, which may be set to “off” and therefore want to reflect as little light as possible. The corrected brightness data may therefore include separate RGB components to drive each of the micro-display modules 1210, 1212, 1214 independently.

A ray analysis may project a test image(s) or test rays on the three-dimensional display screen 1500 to view any lateral secondary color aberrations due to an ultra-wide projection lens. The results of the analysis may also be used to determine where and when color aberrations occur and thereby provide corrected color data. The resulting correction codes may be used to alter color data on a pixel-by-pixel, or pixel block by pixel block, basis.

As mentioned above, the three-dimensional display screen 1500 may originate as a three-dimensional computer design which is made up of numerous polygonal meshes. By referring to the three-dimensional display screen 1500 as a series of polygonal meshes, each 4×4 pixel block may be projected onto the three-dimensional display screen 1500 using the polygonal meshes as a map. Using the four corners of the 4×4 block, a 4-point correlation approach and approximation method of mapping may be used to develop a data matrix to be stored by the three-dimensional controller 107. Each 4×4 block may correspond to an element of the matrix, as mentioned above, and each element may contain a correction code for that element. An approximation method, as used by those of ordinary skill in the art, may be used to simplify the number of control points or the complexity of the polygonal mesh.

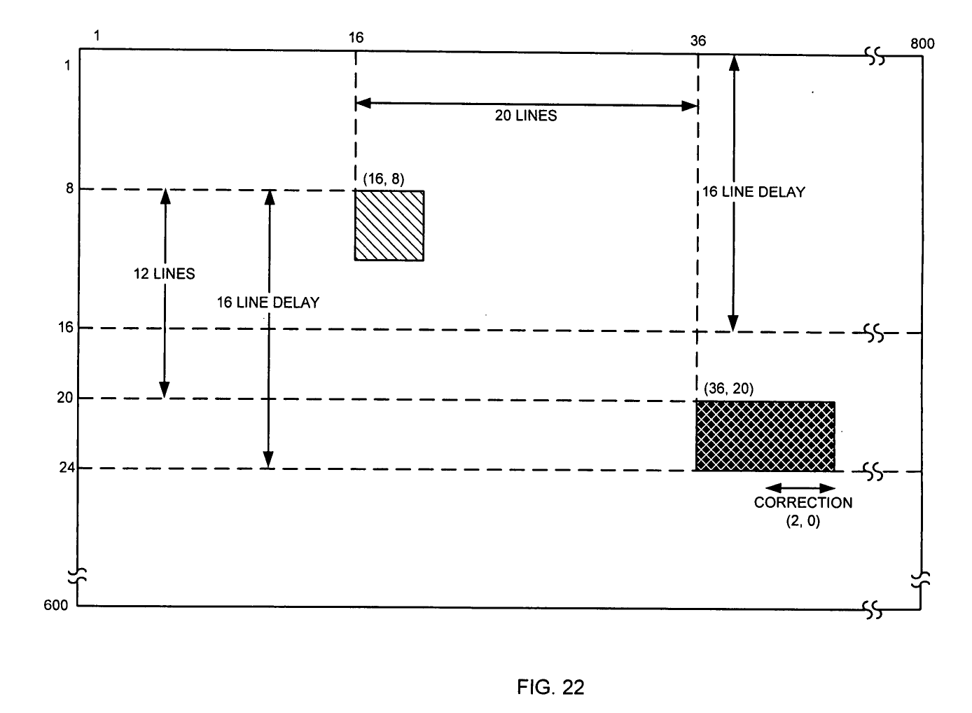

FIG. 22 is a schematic representation of an exemplary depiction of compensating for the difference between a received two-dimensional input video signal 1310 and a displayed three-dimensional image. Compensating for the difference may result in an overall two-dimensional image data being converted for display on a three-dimensional display screen 1500 by correcting for those pixel images that may be distorted and allowing undistorted pixels images to remain unmodified. Referring to FIG. 22, to compensate for the possibility that a displayed 4×4 pixel block may be different than the received 4×4 pixel block due to distortion, the actual display of the video image may be delayed. The delay may be set for 16 horizontal lines causing the three-dimensional image controller 107 to not begin displaying line 1 until line 16 of the input video signal 1310 has been received by the digital video interface 1320. Using a (pixel, line) addressing scheme, the correction code 1334 for the 4×4 pixel block beginning at address (16, 8) may instruct the imaging processor 1330 to move the 4×4 pixel block to address (36, 20) using an offset of (20, 12). A correction value of (2, 0) may be also given to duplicate a pixel every second pixel. The displayed 4×4 pixel block may therefore not only change location, but may also become longer due to the correction value. The pixel block of the actual video image in the image buffer 1340 may remain in the same memory location whereas the corrected pixel block may be displayed at a different video scan address. In other words, using a two-dimensional screen, the pixel block would have been displayed at (16, 8). The corrected pixel block remains at memory address (16, 8) to maintain image integrity (e.g., avoid putting an image of an ear where a cheek should be), but is displayed at video scan address (30, 20) for the three-dimensional display screen 1500. Using LCoS micro-display modules 1210, 1212, 1214, those cells corresponding to video scan address (30, 20) display the corrected pixel block rather than cells (16, 8) which would normally display that same pixel block on a two-dimensional screen. A larger delay may be used if the pixel block correction falls outside of the 16 line delay. Overlaying one displayed pixel block on another may therefore correct for distortion due to displaying a two-dimensional pixel image on an angled surface by making the two-dimensional pixel block image wider, longer or shorter as required. In some instances, such a correction may not needed (e.g., the two-dimensional pixel block image looks the same on the three-dimensional display screen 1500 as on a two-dimensional display), in which case a flag may be set to disable the correction, or the offset code and correction value may each be set to (0, 0).

The brightness value may likewise be used to cause the corrected pixel block to be displayed brighter or dimmer, as required. The ray analysis data may be used to vary the color as needed due to lateral secondary color aberrations. In the example of FIG. 22, the corrected pixel block has been made dimmer and the color has been changed as represented by the cross-hatched markings. As with the offset and correction value, brightness and color corrections may not be needed, in which case the values may be set to zero or a flag may be set to disable the corrections. Additional correction techniques may be provided by other methods including a program sold by Elumens, Inc. under the trademark TruTheta, or using a system and method as disclosed in U.S. Pat. No. 6,104,405, which is expressly incorporated by reference herein.

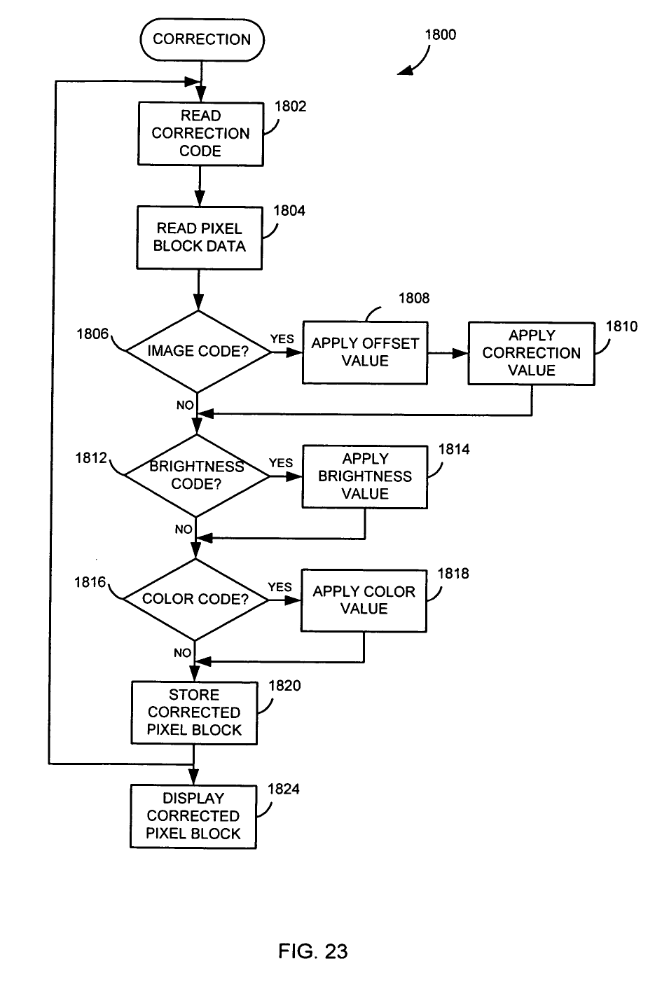

FIG. 23 is a flowchart of a correction routine 1800 that may be stored in the correction memory 1350 of the three-dimensional controller 107 and executed by the imaging processor 1330. Referring to FIG. 23, the correction routine 1800 may begin operation at block 1802 during which the imaging processor 1330 may retrieve and read one or more correction codes from the correction memory 1350. The correction code 1334 may be pre-fetched by the imaging processor 1330 prior to receiving and displaying the pixel block to which the correction code corresponds. For example, the correction code 1334 for the first 4×4 pixel block may be fetched by the imaging processor 107 prior to pixel 1 of line 1 being displayed and may be held by the imaging processor 107 until pixel 4 of line 1 is displayed, during which the next correction code 1334 is fetched for pixels 5-8 of line 1. The same correction code 1334 may again be retrieved and read before pixel 1 of line 2 is displayed.

Upon retrieving the correction code at block 1802, the correction routine 1800 may read the corresponding pixel block data at block 1804 from the image buffer 1340. Generally, the pixel block data is part of a larger set of two-dimensional video frame data used as the two-dimensional input video signal 1310. Each pixel block may include pixel block data relating to size, position, brightness and color. Alternatively, the associated brightness and color stream data may be provided separately from the pixel block data, though read at block 1802 in conjunction with reading the pixel block data. Once the pixel block data is read at block 1804, the correction routine 1800 may apply the correction code.

At block 1806, the correction routine 1800 may determine if there is an image code to apply to the pixel block. The image code may include both an offset code and a correction value, which if applied, may offset the pixel block image to another video scan address and vary the size of the image to correct for image distortion. A flag may be used to indicate the absence of any image code, in which case the correction routine 1800 transfers control to block 1812. If there is an image code to apply, control may be passed to block 1808 where the offset value is read and applied to the pixel block to vary its displayed location. Control may then pass to block 1810, during which a correction value may be applied to vary the shape and size of the pixel block, and hence vary the video scan address. An example of an offset value and a correction value and how they affect the pixel block may be seen with reference to FIG. 22. In some cases, the pixel block may not require an offset or a correction value. For those codes not in use, the codes may be set to zero and the correction routine 1800 may apply the codes at blocks 1808 and 1810, though there is no effect on the pixel block. Following the application of the offset value at block 1808 and the correction value at block 1810, control may be transferred to block 1812.

At block 1812, the correction routine may determine whether there is a brightness code to apply to the pixel block to correct for brightness distortion. If not, a flag may be set to indicate the absence of a code and control may pass to block 1816. If there is a brightness code, even if the code is set to zero, the code may be applied to the pixel block at block 1814. The brightness data of the pixel block may include, or otherwise be associated with, control data that determines how much light the cell(s) of each module 1210, 1212, 1214 are to reflect. The application of a brightness value at block 1814 may therefore vary the control data to cause the particular cell(s) to reflect more or less light as needed. As mentioned above, the control data, and thereby the brightness value, may have a component for each of the RGB colors. It may be desirable to apply blocks 1812 and 1814 after applying the offset and correction value above, because changing the position of the pixel block may also change the cell(s) that will be displaying the pixel block. The brightness value may therefore be dynamic to compensate for a change in position, size or shape, because brightness distortions may occur on the basis of a particular cell position (i.e., brightness distortion always occurs on the same area of the three-dimensional display screen 1500 which is related to a particular cell(s)).

Following the determination at block 1812 or the application of a brightness code at block 1814, control may pass to block 1816 to determine if a color code is to be applied to the pixel block to adjust the color stream data to correct for color aberrations. If not, a flag may be set and control may pass to block 1820. If there is a color code, even if set to zero, control may pass to block 1818 where the color code is applied to the color stream data. Because the color stream data may have a component for each of the RGB colors, the color code may likewise have a component for each of the RGB colors. The color code may be associated with a particular pixel block, a particular cell(s) of the micro-display modules 1210, 1212, 1214 or both. The application of the color code at block 1818 may therefore be dependent on the offset value and correction value applied above, and therefore dynamic to compensate for a change in position, size or shape. Alternatively, the predetermined image codes may be used to predetermine the color codes, After the application of the color code at block 1818, control may pass to block 1820.

Block 1820 of the correction routine may cause the corrected pixel block to be stored in the image buffer 1340. Generally, the corrected pixel block may be stored in the same location as the original pixel block to maintain image integrity, though it will be displayed at a video scan address as determined at blocks 1806, 1808 and 1810. Because a delay may be involved, as mentioned above, the corrected pixel block is stored at block 1820, until it is ready to be displayed. Meanwhile, control may pass back to block 1802 to pre-fetch the next correction code for the next pixel block data to be corrected for display. As mentioned above, the corrections performed during the correction routine 1800 may only be applied to a single line of pixels at a time, which may not be the entire pixel block. The corrected pixel block data may therefore include only corrected pixel block data for those pixels to be displayed, and the same correction code and remaining pixel block data may be read at blocks 1802 and 1804 for further correction.

At block 1822, the imaging processor 1330 may cause the corrected pixel block to be transferred to the micro-display drive 1360 for transmission of non-planar, three-dimensional video image data to the micro-display engine 1200 via the I/O circuit 108 and data cables 1700. In some cases, the color stream data and brightness data may be stored and provided separately from the pixel block. Likewise, corrected color stream data and corrected brightness data may be stored and provided separately from the corrected pixel block, though all three may be corrected in conjunction with one another. The correction routine 1800 may include re-combining the corrected color stream data, corrected brightness data and corrected pixel block data at block 1822, while also parsing out various components for control over each micro-display module 1210, 1212, 1214, such as parsing out the corrected brightness and corrected color stream data to the various red, green and blue micro-display modules 1210, 1212, 1214. While block 1822 may be performed by the imaging processor 1330, one or more of these functions may also be carried out by the micro-display drive 1360 or I/O circuit 108 at the control of the imaging processor. The resulting combination of corrected pixel block data, corrected color stream data and corrected brightness data is part of a large matrix of data relating to a frame of a non-planar, three-dimensional video signal that, when projected on a three-dimensional display screen 1500, may be viewed as a non-planar, three-dimensional video image with little or no distortion.

Returning to FIG. 21, the imaging processor 1330 may add the color stream data and brightness data (which may be modified based on the brightness and color corrections), covert the pixel address to row and column addresses for display by the micro-display engine 1200 (if the image resolution and micro-display module resolution are different), and generate control data 1336 for all the above. Each micro-display module 1210, 1212, 1214 may receive 8 bits of the 24-bit corrected video signal 1342. Each 8-bit portion corresponds to a particular RGB color and provides 256 levels of that corresponding color. Each micro-display module 1210, 1212, 1214 may further receive the corrected pixel address bits, which are generally the same for each module 1210, 1212, 1214 because each pixel includes color data corresponding to a red, green and blue component to display its image (even if an RGB component is set to zero). The micro-display drive 1360 may initially receive the corrected video data 1342 and the control data 1336, and multiplex/diplex the data as needed for each micro-display module 1210, 1212, 1214. For example, the micro-display drive 1360 may receive the corrected video data 1342 corresponding to the first 4×4 pixel block, copy that data for each micro-display module 1210, 1212, 1214, apply color and brightness data specific to each micro-display module 1210, 1212, 1214, etc. The three-dimensional video data may then be sent to its specific micro-display module 1210, 1212, 1214. Although the micro-display modules 1210, 1212, 1214 may include a micro-display controller for frame buffering, timing and digital-to-analog conversion, some or all of these functions may be performed by the three-dimensional controller 107.

### Control

The components 52, 54, 56, 58, 66 of a gaming unit 20 may be detached from the three-dimensional display screen 1500, and some may be bypassed altogether. For example, the control panel 66 may be replaced with a touch-sensitive, motion-sensitive or wireless controls. An image of the various buttons normally provided on the control panel 66 may be displayed on the three-dimensional display screen 1500. The player may select a displayed button or otherwise initiate control by using a wireless device, such as a personal digital assistant, a cellular phone, a laptop computer, etc. Alternatively, a displayed button may be selected by touching the screen or motioning towards the button image with a hand or finger. Motion sensors may detect the motion of the hand or finger motioning towards the button image using infrared or radiowave sensors, which may signal the player's selection to the controller 100. The use of a dome 1510 provides a z-axis or depth to a player's movements. Therefore, a controller 100 may be able to read not only the player's vertical and horizontal (e.g., left to right, up and down) position of the hand, but also the depth of the position of the hand to distinguish between regular movement and intentional movement to make a selection. Wireless sensors connected to the player's finger, hand, arm or body may likewise transmit motioning information to the controller 100. Joysticks, a mouse and other controls of the like may also be used. The non-planar, three-dimensional images projected on the three-dimensional display screen 1500 may therefore be reactive to a player's movements, allowing interactivity between the player and a game or any other image provided.

1. A gaming apparatus, comprising:
a display unit capable of generating a non-planar, three-dimensional video image, said display unit comprising first and second non-planar, three-dimensional display screens each capable of displaying a non-planar, three-dimensional video image;
a value input device;
a controller operatively coupled to said display unit and said value input device, said controller comprising a processor and a memory operatively coupled to said processor,
said controller being programmed to allow a person to make a wager,
said controller being programmed to read a predetermined correction code comprising at least one of the following: an offset value, a correction value, a color value and a brightness value,
said controller being programmed to convert two-dimensional image data into three-dimensional image data by correcting for at least one of the following using said correction code: image distortion, brightness distortion and color aberrations when said two-dimensional image data is displayed on said non-planar, three-dimensional display screen as a video image, wherein said predetermined correction code is associated with correcting one or more pixels of said two-dimensional image data;
said controller being programmed to cause a first non-planar, three-dimensional video image to be generated on said first non-planar, three-dimensional display screen from said three-dimensional image data, said first non-planar, three-dimensional video image representing a game,
said controller being programmed to cause a second non-planar, three-dimensional video image to be generated on said second non-planar, three-dimensional display screen from said three-dimensional image data, said second non-planar, three-dimensional video image representing a bonus game,
said controller being programmed to determine, after said first non-planar, three-dimensional video image has been displayed, a value payout associated with an outcome of said game represented by said first three-dimensional video image,
said controller being programmed to determine, after said second non-planar, three-dimensional video image has been displayed, a value payout associated with an outcome of said bonus game represented by said second three-dimensional video image.

2. A gaming apparatus as defined in claim 1, wherein said first and second non-planar, three-dimensional display screens each comprise an inner surface and an outer surface, and wherein said first and second non-planar, three-dimensional video images are projected on said inner surfaces and viewed by said person on said outer surfaces.

3. A gaming apparatus, comprising:
a display unit capable of generating a non-planar, three-dimensional video image, said display unit comprising a non-planar, three-dimensional display screen in the shape of a dome and capable of displaying said non-planar, three-dimensional video image,
a value input device;
a controller operatively coupled to said display unit and said value input device, said controller comprising a processor and a memory operatively coupled to said processor,
said controller being programmed to allow a person to make a wager;
said controller being programmed to convert two-dimensional image data into three-dimensional image data by correcting for at least one of the following distortions: image distortion, brightness distortion and color aberrations when said two-dimensional image data is displayed on said non-planar, three-dimensional display screen as a video image
said controller being programmed to translate one or more pixels of said two-dimensional image data if said distortion comprises image distortion,
said controller being programmed to vary the size of one or more pixels of said two-dimensional image data if said distortion comprises image distortion,
said controller being programmed to adjust the brightness of one or more pixels of said two-dimensional image data if said distortion comprises brightness distortion,
said controller being programmed to adjust the color of one or more pixels of said two-dimensional image data if said distortion comprises color aberrations,
said controller being programmed to cause a non-planar, three-dimensional video image to be generated on said display unit from said three-dimensional image data, said non-planar, three-dimensional video image representing a game,
said controller being programmed to determine, after said non-planar, three-dimensional video image has been displayed, a value payout associated with an outcome of said game represented by said three-dimensional video image.

4. A gaming apparatus as defined in claim 3, wherein said non-planar, three-dimensional display screen comprises an inner surface and an outer surface, and wherein said non-planar, three-dimensional video image is projected on said inner surface and viewed by said person on said inner surface.

5. A gaming apparatus, comprising:
a display unit capable of generating a non-planar, three-dimensional video image, said display unit comprising a non-planar, three-dimensional display screen capable of displaying said non-planar, three-dimensional video image;
a value input device;
a controller operatively coupled to said display unit and said value input device, said controller comprising a processor and a memory operatively coupled to said processor,
said controller being programmed to allow a person to make a wager,
said controller being programmed to convert two-dimensional image data into three-dimensional image data,
said controller being programmed to cause a non-planar, three-dimensional video image representing a game to be generated on said display unit from said three-dimensional image data, said non-planar, three-dimensional video image representing one of the following games: video poker, video blackjack, video slots, video keno or video bingo,
said non-planar, three-dimensional video image comprising an image of at least five playing cards if said game comprises video poker,
said non-planar, three-dimensional video image comprising an image of a plurality of simulated slot machine reels if said game comprises video slots,
said non-planar, three-dimensional video image comprising an image of a plurality of playing cards if said game comprises video blackjack,
said non-planar, three-dimensional video image comprising an image of a plurality of keno numbers if said game comprises video keno,
said non-planar, three-dimensional video image comprising an image of a bingo grid if said game comprises video bingo, and
said controller being programmed to determine a value payout associated with an outcome of said game.

6. A gaming apparatus as defined in claim 5, wherein said display unit further comprises a light engine capable of producing light in ranges of about 600-650 nanometers, 500-550 nanometers and 440-490 nanometers.

7. A gaming apparatus as defined in claim 5, wherein said display unit further comprises a projection lens assembly capable of projecting said non-planar, three-dimensional video image onto said non-planar, three-dimensional display screen.

8. A gaming apparatus as defined in claim 5, wherein said non-planar, three-dimensional display screen comprises the shape of a dome.

9. A gaming apparatus as defined in claim 5, wherein said non-planar, three-dimensional display screen comprises a shape of a human face and wherein said controller is programmed to cause a non-planar, three-dimensional video image of a face to be generated on said non-planar, three dimensional display screen.

10. A gaming apparatus as defined in claim 5, wherein said non-planar, three-dimensional display screen comprises a shape of a half-cylinder.

11. A gaming apparatus as defined in claim 5, wherein said non-planar, three-dimensional display screen comprises an inner surface and an outer surface, and wherein said non-planar, three-dimensional video image is projected on said inner surface and viewed by said person on said outer surface.

12. A gaming apparatus as defined in claim 5, wherein said non-planar, three-dimensional display screen comprises an inner surface and an outer surface, and wherein said non-planar, three-dimensional video image is projected on said inner surface and viewed by said person on said inner surface.

13. A gaming apparatus as defined in claim 5, wherein said controller further comprises a three-dimensional image controller,
said three-dimensional image controller being programmed to receive said two-dimensional image data;
said three-dimensional image controller being programmed to correct said two-dimensional image data for at least one of the following: image distortion, brightness distortion and color aberrations when said two-dimensional image data is displayed on said non-planar, three-dimensional display screen as a video image; and
said three-dimensional image controller being programmed to cause said corrected two-dimensional image data to be displayed as a non-planar, three-dimensional video image on said non-planar, three-dimensional display screen.

14. A gaming apparatus as defined in claim 5, wherein said controller comprises a three-dimensional image controller, said three-dimensional image controller comprising an image processor and a correction memory operatively coupled to said image processor,
said three-dimensional image controller being programmed to translate one or more pixels of said two-dimensional image data to correct for image distortion;
said three-dimensional image controller being programmed to vary the size of one or more pixels of said two-dimensional image data to correct for image distortion;
said three-dimensional image controller being programmed to adjust the color of one or more pixels of said two-dimensional image data to correct for color aberrations; and
said three-dimensional image controller being programmed to adjust the brightness of one or more pixels of said two-dimensional image data to correct for brightness distortions.

15. A gaming apparatus as defined in claim 5,
wherein said controller is programmed to receive three-dimensional image data, said three-dimensional image data comprising at least one of the following: planar three-dimensional image data and non-planar three-dimensional image data,
wherein said controller is programmed to correct for at least one of the following: image distortion, brightness distortion and color aberrations when said three-dimensional image data is displayed on said non-planar, three-dimensional display screen as a video image, and
wherein said controller is programmed to cause a non-planar, three-dimensional video image representing a game to be generated on said display unit from said corrected three-dimensional image data.

16. A gaming system comprising a plurality of gaming apparatuses as defined in claim 5, said gaming apparatuses being interconnected to form a network of gaming apparatuses.

17. A gaming system as defined in claim 16, wherein said gaming apparatuses are interconnected via the Internet.

18. A gaming apparatus, comprising:
a display unit capable of generating a non-planar, three-dimensional video image, said display unit comprising a non-planar, three-dimensional display screen capable of displaying said non-planar, three-dimensional video image;
a value input device;
a controller operatively coupled to said display unit and said value input device, said controller comprising a processor and a memory operatively coupled to said processor,
said controller being programmed to allow a person to make a wager;
said controller being programmed to covert two-dimensional image data into three-dimensional image data,
said controller being programmed to cause a non-planar, three-dimensional video image to be generated on said display unit from said three-dimensional image data, said non-planar, three-dimensional video image representing a game,
said controller being programmed to determine, after said non-planar, three-dimensional video image has been displayed, a value payout associated with an outcome of said game represented by said three-dimensional video image.

19. A gaming apparatus as defined in claim 18, wherein said display unit further comprises a light engine capable of producing light in ranges of about 600-650 nanometers, 500-550 nanometers and 440-490 nanometers.

20. A gaming apparatus as defined in claim 18, wherein said display unit further comprises a projection lens assembly capable of projecting said non-planar, three-dimensional video image onto said non-planar, three-dimensional display screen

21. A gaming apparatus as defined in claim 18, wherein said non-planar, three-dimensional display comprises the shape of a dome.

22. A gaming apparatus as defined in claim 21, wherein said dome comprises a diameter in the range of about 144-163 centimeters and a radius of curvature of about 53-84 centimeters.

23. A gaming apparatus as defined in claim 18, wherein said display unit comprises a second display screen.

24. A gaming apparatus as defined in claim 23, wherein said second display screen is a planar, two-dimensional display screen.

25. A gaming apparatus as defined in claim 23, wherein said second display screen is a non-planar, three-dimensional display screen.

26. A gaming apparatus as defined in claim 18, wherein said non-planar, three-dimensional display screen comprises a shape of a human face and wherein said controller is programmed to cause a non-planar, three-dimensional video image of a face to be generated on said non-planar, three dimensional display screen.

27. A gaming apparatus as defined in claim 18, wherein said non-planar, three-dimensional display screen comprises a shape of a half-cylinder.

28. A gaming apparatus as defined in claim 18, wherein said controller is programmed to cause a non-planar, three-dimensional video image representing at least one of the following to be generated on said non-planar, three-dimensional display screen: a bonus game, a payout table, casino information, game information, game instructions, an advertisement, a movie, an animation an attraction sequence.

29. A gaming apparatus as defined in claim 18, wherein said non-planar, three-dimensional display screen comprises an inner surface and an outer surface, and wherein said non-planar, three-dimensional video image is projected on said inner surface and viewed by said person on said outer surface.

30. A gaming apparatus as defined in claim 18, wherein said non-planar, three-dimensional display screen comprises an inner surface and an outer surface, and wherein said non-planar, three-dimensional video image is projected on said inner surface and viewed by said person on said inner surface.

31. A gaming apparatus as defined in claim 18, wherein said controller further comprises a three-dimensional image controller,
said three-dimensional image controller being programmed to receive said two-dimensional image data;
said three-dimensional image controller being programmed to correct said two-dimensional image data for at least one of the following: image distortion, brightness distortion and color aberrations when said two-dimensional image data is displayed on said non-planar, three-dimensional display screen as a video image; and
said three-dimensional image controller being programmed to cause said corrected two-dimensional image data to be displayed as a non-planar, three-dimensional video image on said non-planar, three-dimensional display screen.

32. A gaming apparatus as defined in claim 18, wherein said controller comprises a three-dimensional image controller, the three-dimensional image controller comprising an image processor and a correction memory operatively coupled to said image processor,
said three-dimensional image controller being programmed to translate one or more pixels of said two-dimensional image data to correct for image distortion;
said three-dimensional image controller being programmed to vary the size of one or more pixels of said two-dimensional image data to correct for image distortion;
said three-dimensional image controller being programmed to adjust the color of one or more pixels of said two-dimensional image data to correct for color aberrations; and
said three-dimensional image controller being programmed to adjust the brightness of one or more pixels of said two-dimensional image data to correct for brightness distortions.

33. A gaming apparatus as defined in claim 18, further comprising one or more controls operatively coupled to said controller, said controls being capable of allowing said person to manipulate said three-dimensional video image.

34. A gaming apparatus as defined in claim 33, wherein said controls comprise at least one of motion-sensitive controls responsive to a person's movements, touch-sensitive controls responsive to said person touching said non-planar, three-dimensional display screen, and controls responsive to said person's eye movements.

35. A gaming apparatus as defined in claim 18,
wherein said controller is programmed to receive three-dimensional image data, said three-dimensional image data comprising at least one of the following: planar three-dimensional image data and non-planar three-dimensional image data,
wherein said controller is programmed to correct for at least one of the following: image distortion, brightness distortion and color aberrations when said three-dimensional image data is displayed on said non-planar, three-dimensional display screen as a video image, and
wherein said controller is programmed to cause a non-planar, three-dimensional video image representing a game to be generated on said display unit from said corrected three-dimensional image data.

36. A gaming system, comprising a plurality of gaming apparatuses as defined in claim 18, said gaming apparatuses being interconnected to form a network of gaming apparatuses.

37. A gaming apparatus, comprising:
a display unit capable of generating non-planar, three-dimensional video images, said display unit comprising a non-planar, three-dimensional display screen capable of displaying said non-planar, three-dimensional video images;
a value input device;
a controller operatively coupled to said display unit and said value input device, said controller comprising a processor and a memory operatively coupled to said processor,
said controller being programmed to allow a person to make a wager,
said controller being programmed to allow a person to make a payline selection,
said controller being programmed to convert two-dimensional image data into three-dimensional image data;
said controller being programmed to cause a non-planar, three-dimensional video image to be generated on said display unit from said three-dimensional image data, said non-planar, three-dimensional video image comprising a plurality of simulated slot machine reels of a slots game, each of said slot machine reels having a plurality of slot machine symbols,
said controller being programmed to determine a value payout associated with an outcome of said slots game, said controller being programmed to determine said outcome of said slots game based on a configuration of said slot machine symbols.

38. A gaming apparatus as defined in claim 37, wherein said controller is programmed to allow a user to select a number of paylines.

39. A gaming apparatus as defined in claim 37, wherein said non-planar, three-dimensional display comprises the shape of a dome.

40. A gaming apparatus as defined in claim 37, wherein said non-planar, three-dimensional display screen comprises an inner surface and an outer surface, and wherein said non-planar, three-dimensional video image is projected on said inner surface and viewed by said person on said outer surface.

41. A gaming apparatus as defined in claim 37, wherein said non-planar, three-dimensional display screen comprises an inner surface and an outer surface, and wherein said non-planar, three-dimensional video image is projected on said inner surface and viewed by said person on said inner surface.

42. A gaming apparatus as defined in claim 37, wherein said controller further comprises a three-dimensional image controller,
said three-dimensional image controller being programmed to receive said two-dimensional image data;
said three-dimensional image controller being programmed to correct said two-dimensional image data for at least one of the following: image distortion, brightness distortion and color aberrations when said two-dimensional image data is displayed on said non-planar, three-dimensional display screen as a video image;
said three-dimensional image controller being programmed to cause said corrected two-dimensional image data to be displayed as a non-planar, three-dimensional video image on said non-planar, three-dimensional display screen.

43. A gaming apparatus as defined in claim 42, wherein said controller comprises a three-dimensional image controller, the three-dimensional image controller comprising an image processor and a correction memory operatively coupled to said image processor,
said three-dimensional image controller being programmed to translate one or more pixels of said two-dimensional image data to correct for image distortion;
said three-dimensional image controller being programmed to vary the size of one or more pixels of said two-dimensional image data to correct for image distortion;
said three-dimensional image controller being programmed to adjust the color of one or more pixels of said two-dimensional image data to correct for color aberrations; and
said three-dimensional image controller being programmed to adjust the brightness of one or more pixels of said two-dimensional image data to correct for brightness distortions.

44. A gaming apparatus as defined in claim 37,
wherein said controller is programmed to receive three-dimensional image data, said three-dimensional image data comprising at least one of the following: planar three-dimensional image data and non-planar three-dimensional image data,
wherein said controller is programmed to correct for at least one of the following: image distortion, brightness distortion and color aberrations when said three-dimensional image data is displayed on said non-planar, three-dimensional display screen as a video image, and
wherein said controller is programmed to cause a non-planar, three-dimensional video image representing a game to be generated on said display unit from said corrected three-dimensional image data.

45. A gaming system comprising a plurality of gaming apparatuses as defined in claim 37, said gaming apparatuses being interconnected to form a network of gaming apparatuses.

46. A gaming method comprising:
receiving two-dimensional image data;
converting said two-dimensional image data into three-dimensional image data;
causing a non-planar, three-dimensional video image representing a game to be generated on a non-planar, three-dimensional display screen from said three-dimensional image data, said three-dimensional video image representing one of the following games: video poker, video blackjack, video slots, video keno or video bingo,
said non-planar, three-dimensional video image comprising an image of at least five playing cards if said game comprises video poker,
said non-planar, three-dimensional video image comprising an image of a plurality of simulated slot machine reels if said game comprises video slots,
said non-planar, three-dimensional video image comprising an image of a plurality of playing cards if said game comprises video blackjack,
said non-planar, three-dimensional video image comprising an image of a plurality of keno numbers if said game comprises video keno, and
said non-planar, three-dimensional video image comprising an image of a bingo grid if said game comprises video bingo; and
determining a value payout associated with an outcome of said game represented by said non-planar, three-dimensional video image.

47. A gaming method as defined in claim 46, additionally comprising correcting said two-dimensional image data for at least one of the following: image distortion, brightness distortion and color aberrations when said two-dimensional image data is displayed on said non-planar, three-dimensional display screen as video image.

48. A gaming method as defined in claim 46, additionally comprising one or more of the following:
translating one or more pixels of said two-dimensional image data to correct for image distortion;
varying the size of one or more pixels of said two-dimensional image data to correct for image distortion;
adjusting the color of one or more pixels of said two-dimensional image data to correct for color aberrations; and
adjusting the brightness of one or more pixels of said two-dimensional image data to correct for brightness distortions.

49. A gaming method as defined in claim 46, additionally comprising:
receiving three-dimensional image data, said three-dimensional image data comprising at least one of the following: planar three-dimensional image data and non-planar three-dimensional image data,
correcting said three-dimensional image data for at least one of the following: image distortion, brightness distortion and color aberrations when said three-dimensional image data is displayed on said non-planar, three-dimensional display screen as a video image, and
causing a non-planar, three-dimensional video image representing a game to be generated on said display unit from said corrected three-dimensional image data.
